(19) United States
(12) Patent Application Publication
(10) Pub. No.: US 2025/0164850 A1
(43) Pub. Date: May 22, 2025

(54) LENS DEVICE

(71) Applicant: FUJIFILM Corporation, Tokyo (JP)

(72) Inventor: Yujiro YANAI, Minamiashigara-shi (JP)

(73) Assignee: FUJIFILM Corporation, Tokyo (JP)

(21) Appl. No.: 19/031,008

(22) Filed: Jan. 17, 2025

Related U.S. Application Data
(63) Continuation of application No. PCT/JP2023/025918, filed on Jul. 13, 2023.

(30) Foreign Application Priority Data
Aug. 2, 2022 (JP) 2022-123211

(51) Int. Cl. G02F 1/29

(52) U.S. Cl. CPC G02F 1/294

(57) ABSTRACT

Provided is a small lens device where a focal length is variable. Each of first and second liquid crystal layers includes a circular center portion and a plurality of annular portions, the first and second liquid crystal layers are rotatable relative to each other, inner diameters and outer diameters of the n-th annular portions from the center portions of the first and second liquid crystal layers are the same, and in polar coordinates of r and φ, in a case where a pattern where an angle θ₁ of an optical axis in a region where φ is φ₁ satisfies a relationship represented by Expression 3: {α₁×φ₁+θ₀ₙ₁}−3°≤θ₁≤{α₁×φ₁+θ₀ₙ₁}+3° (where θ₀ₙ₁ represents an angle of the optical axis of each of the center portion and the annular portions at φ₁=0°) is set as a vortex alignment pattern, the center portion of the first liquid crystal layer has a vortex alignment pattern where α₁=m×0.5, the n-th annular portion of the first liquid crystal layer has a vortex alignment pattern where α₁=(m+n)×0.5, the center portion of the second liquid crystal layer has a vortex alignment pattern where α₂=−(m×0.5), and the n-th annular portion of the second liquid crystal layer has a vortex alignment pattern where α₂=−(m+n)×0.5.

### CROSS-REFERENCE TO RELATED APPLICATIONS

This application is a Continuation of PCT International Application No. PCT/JP2023/025918 filed on Jul. 13, 2023, which claims priority under 35 U.S.C. § 119 (a) to Japanese Patent Application No. 2022-123211 filed on Aug. 2, 2022. The above applications are hereby expressly incorporated by reference, in their entirety, into the present application.

### BACKGROUND OF THE INVENTION

### 1. Field of the Invention

The present invention relates to a lens device where a focal length is variable.

### 2. Description of the Related Art

In a head mounted display (HMD) such as augmented reality (AR) glasses, virtual reality (VR) glasses, or mixed reality (MR) glasses, a lens for focusing a video on a pupil of a user is provided. In a case where the user wears the head mounted display, a relative position between the HMD and the pupil changes depending on the user. Therefore, the lens moves in an optical axis direction to change the focal length of the lens. In this case, the thickness of the HMD in the optical axis direction increases, and a sufficient reduction in size cannot be achieved.

On the other hand, U.S. Pat. No. 10,877,277B describes an Alvarez lens where two liquid crystal films having a lens action are translated relative to each other in an in-plane direction to change the focal length of the lens.

### SUMMARY OF THE INVENTION

However, in the configuration described in U.S. Pat. No. 10,877,277B where the two liquid crystal films are translated in the in-plane direction, although the thickness of the lens in the optical axis direction can be reduced, the size of a region acting as the lens is less than that of the liquid crystal film, and a space for translating the two liquid crystal films is required. Therefore, the size in the in-plane direction increases, and a reduction in size is not sufficient.

An object of the present invention is to solve the above-described problem of the related art and to provide a small lens device where a focal length is variable.

In order to achieve the object, the present invention has the following configurations.

[1] A lens device comprising:
a first liquid crystal layer; and
a second liquid crystal layer,
in which each of the first liquid crystal layer and the second liquid crystal layer includes a circular center portion and a plurality of annular portions that have centers matching with a center of the center portion and have different inner diameters provided in a radial direction of the center portion,
the center of the center portion of the first liquid crystal layer and the center of the center portion of the second liquid crystal layer match with each other in an in-plane direction,
the first liquid crystal layer and the second liquid crystal layer are rotatable relative to each other around the center of the center portion of the first liquid crystal layer without changing a distance between the first liquid crystal layer and the second liquid crystal layer,
an inner diameter rᵢₙ₋ₙ₁ and an outer diameter rₒᵤₜ₋ₙ₁ of an n-th annular portion from the center portion of the first liquid crystal layer and an inner diameter rᵢₙ₋ₙ₂ and an outer diameter rₒᵤₜ₋ₙ₂ of an n-th annular portion from the center portion of the second liquid crystal layer satisfy relationships represented by Expression 1 and Expression 2,

$$0 \text{.9} \times {r}_{i n - n 1} \leq {r}_{i n - n 2} \leq 1.1 \times {r}_{i n - n 1} , \qquad Expression 1$$

$$and$$

$$0.9 \times {r}_{o u t - n 1} \leq {r}_{o u t - n 2} \leq 1.1 \times {r}_{o u t - n 1} , \qquad Expression 2$$

in polar coordinates of r and φ with respect to the center of the center portion of the first liquid crystal layer as an origin, in a case where a pattern where an angle θ₁ [°] of an optical axis of the first liquid crystal layer in a region where φ is φ₁ satisfies a relationship represented by Expression 3 is set as a vortex alignment pattern,

$$Expression 3$$

$$\{ {α}_{1} \times {φ}_{1} + {θ}_{0 n 1} \} - 3 ° \leq {θ}_{1} \leq \{ {α}_{1} \times {φ}_{1} + {θ}_{0 n 1} \} + 3 ° ,$$

where θ₀ₙ₁ [°] represents an angle of the optical axis of each of the center portion and the annular portions at φ₁=0°,
the center portion of the first liquid crystal layer has a vortex alignment pattern where α₁=m×0.5 in a case where m represents an integer of 1 or more, and
the n-th annular portion from the center portion of the first liquid crystal layer has a vortex alignment pattern where α₁=(m+n)×0.5, and
in polar coordinates of r and φ with respect to the center of the center portion of the second liquid crystal layer as an origin, in a case where a pattern where an angle θ₂ [°] of an optical axis of the second liquid crystal layer in a region where φ is φ₂ satisfies a relationship represented by Expression 4 is set as a vortex alignment pattern,

$$Expression 4$$

$$\{ {α}_{2} \times {φ}_{2} + {θ}_{0 n 2} \} - 3 ° \leq {θ}_{2} \leq \{ {α}_{2} \times {φ}_{2} + {θ}_{0 n 2} \} + 3 ° ,$$

where θ₀ₙ₂ [°] represents an angle of the optical axis of each of the center portion and the annular portions at φ₂=0°,
the center portion of the second liquid crystal layer has a vortex alignment pattern where α₂=−(m×0.5) in a case where m represents an integer of 1 or more, and
the n-th annular portion from the center portion of the second liquid crystal layer has a vortex alignment pattern where α₂=−(m+n)×0.5.

[2] The lens device according to [1],
in which in a case where an azimuthal angle at which the optical axis is parallel to the radial direction in the n-th annular portion from the center portion with respect to an orientation at which the optical axis is parallel to the radial direction in the center portion of the first liquid crystal layer is represented by φₙ₁, and
an azimuthal angle at which the optical axis is parallel to the radial direction in the n-th annular portion from the center portion with respect to an orientation at which the optical axis is parallel to the radial direction in the center portion of the second liquid crystal layer is represented by φₙ₂,
φₙ₁=φₙ₂ is satisfied.

[3] The lens device according to [2],
in which in a case where the azimuthal angle at which the optical axis is parallel to the radial direction in the center portion of the first liquid crystal layer is represented by φ₀₁, φₙ₁=φ₀₁ is satisfied, and
in a case where the azimuthal angle at which the optical axis is parallel to the radial direction in the center portion of the second liquid crystal layer is represented by φ₀₂, φₙ₂=φ₀₂ is satisfied.

[4] The lens device according to any one of [1] to [3], which functions as an axicon lens.

[5] The lens device according to any one of [1] to [3], which functions as a spherical lens.

[6] The lens device according to any one of [1] to [3], which functions as an aspherical lens.

According to the present invention, a small lens device where a focal length is variable can be provided.

### BRIEF DESCRIPTION OF THE DRAWINGS

FIG. 1 is a perspective view conceptually showing an example of a lens device according to the present invention.

FIG. 2 is a side view conceptually showing an example of a liquid crystal layer in the lens device according to the present invention.

FIG. 3 is a plan view conceptually showing an example of a first liquid crystal layer in the lens device according to the present invention.

FIG. 4 is a partially enlarged view showing the first liquid crystal layer shown in FIG. 3.

FIG. 5 is a diagram showing a phase in the liquid crystal layer in the lens device according to the present invention.

FIG. 6 is an enlarged plan view conceptually showing a part of the example of the first liquid crystal layer in the lens device according to the present invention.

FIG. 7 is a conceptual diagram showing a vortex alignment pattern of the first liquid crystal layer.

FIG. 8 is an enlarged plan view conceptually showing a part of an example of a second liquid crystal layer in the lens device according to the present invention.

FIG. 9 is a conceptual diagram showing a vortex alignment pattern of the second liquid crystal layer.

FIG. 10 is a diagram conceptually showing a phase of the lens device.

FIG. 11 is a diagram conceptually showing a phase of the lens device.

FIG. 12 is a diagram conceptually showing a phase of the lens device.

FIG. 13 is a diagram conceptually showing a phase of the lens device.

FIG. 14 is a diagram showing an action of the lens device according to the present invention.

FIG. 15 is a diagram conceptually showing a phase of the lens device.

FIG. 16 is a diagram showing the action of the lens device according to the present invention.

FIG. 17 is a conceptual diagram showing an example of an exposure device that exposes an alignment film for forming the liquid crystal layer.

FIG. 18 is a plan view conceptually showing a vortex alignment pattern of the first liquid crystal layer prepared in Example.

FIG. 19 is a plan view conceptually showing a vortex alignment pattern of the second liquid crystal layer prepared in Example.

FIG. 20 is a conceptual diagram showing a measurement system that measures a focal length.

FIG. 21 is a diagram showing the influence of error of the vortex alignment pattern.

FIG. 22 is a diagram showing the influence of error of the vortex alignment pattern.

### DESCRIPTION OF THE PREFERRED EMBODIMENTS

Hereinafter, a lens device according to an embodiment of the present invention will be described in detail based on preferable embodiments shown in the accompanying drawings.

In the present specification, numerical ranges represented by “to” include numerical values before and after “to” as lower limit values and upper limit values.

In the present specification, the meaning of the term “the same”, “identical”, or the like includes a case where an error range is generally allowable in the technical field.

In the present specification, “(meth)acrylate” represents “either or both of acrylate and methacrylate”.

In the present specification, Re(λ) represents an in-plane retardation at a wavelength λ. Unless specified otherwise, the wavelength λ refers to 550 nm.

In the present specification, Re(λ) is a value measured at the wavelength λ using AxoScan (manufactured by Axometrics, Inc.). By inputting an average refractive index ((nx+ny+nz)/3) and a film thickness (d (μm)) to AxoScan, the following expression

### Slow Axis Direction (°)

Re(λ)=R0(λ)
are calculated.

R0(λ) is expressed as a numerical value calculated by AxoScan and represents Re(λ).

### [Lens Device]

A lens device according to an embodiment of the present invention comprising:
a first liquid crystal layer; and
a second liquid crystal layer,
in which each of the first liquid crystal layer and the second liquid crystal layer includes a circular center portion and a plurality of annular portions that have centers matching with a center of the center portion and have different inner diameters provided in a radial direction of the center portion,
the center of the center portion of the first liquid crystal layer and the center of the center portion of the second liquid crystal layer match with each other in an in-plane direction,
the first liquid crystal layer and the second liquid crystal layer are rotatable relative to each other around the center of the center portion of the first liquid crystal layer without changing a distance between the first liquid crystal layer and the second liquid crystal layer,
an inner diameter rᵢₙ₋ₙ₁ and an outer diameter rₒᵤₜ₋ₙ₁ of an n-th annular portion from the center portion of the first liquid crystal layer and an inner diameter rᵢₙ₋ₙ₂ and an outer diameter Tₒᵤₜ₋ₙ₂ of an n-th annular portion from the center portion of the second liquid crystal layer satisfy relationships represented by Expression 1 and Expression 2,

$$0 \text{.9} \times {r}_{i n - n 1} \leq {r}_{i n - n 2} \leq 1.1 \times {r}_{i n - n 1} , \qquad Expression 1$$

$$and$$

$$0.9 \times {r}_{out - n 1} \leq {r}_{out - n 2} \leq 1.1 \times {r}_{out - n 1} , \qquad Expression 2$$

in polar coordinates of r and φ with respect to the center of the center portion of the first liquid crystal layer as an origin, in a case where a pattern where an angle θ₁ [°] of an optical axis of the first liquid crystal layer in a region where φ is φ₁ satisfies a relationship represented by Expression 3 is set as a vortex alignment pattern,

$$\{ {α}_{1} \times {φ}_{1} + {θ}_{0 n 1} \} - 3 ° \leq {θ}_{1} \leq \{ {α}_{1} \times {φ}_{1} + {θ}_{0 n 1} \} + 3 ° \qquad Expression 3$$

where θ₀ₙ₁ [°] represents an angle of the optical axis of each of the center portion and the annular portions at φ₁=0°,
the center portion of the first liquid crystal layer has a vortex alignment pattern where α₁=m×0.5 in a case where m represents an integer of 1 or more, and
the n-th annular portion from the center portion of the first liquid crystal layer has a vortex alignment pattern where α₁=(m+n)×0.5, and
in polar coordinates of r and φ with respect to the center of the center portion of the second liquid crystal layer as an origin, in a case where a pattern where an angle θ₂ [°] of an optical axis of the second liquid crystal layer in a region where φ is φ₂ satisfies a relationship represented by Expression 4 is set as a vortex alignment pattern,

$$\{ {α}_{2} \times {φ}_{2} + {θ}_{0 n 2} \} - 3 ° \leq {θ}_{2} \leq \{ {α}_{2} \times {φ}_{2} + {θ}_{0 n 2} \} + 3 ° , \qquad Expression 4$$

where θ₀ₙ₂ [°] represents an angle of the optical axis of each of the center portion and the annular portions at φ₂=0°,
the center portion of the second liquid crystal layer has a vortex alignment pattern where α₂=−(m×0.5) in a case where m represents an integer of 1 or more, and
the n-th annular portion from the center portion of the second liquid crystal layer has a vortex alignment pattern where α₂=−(m+n)×0.5.

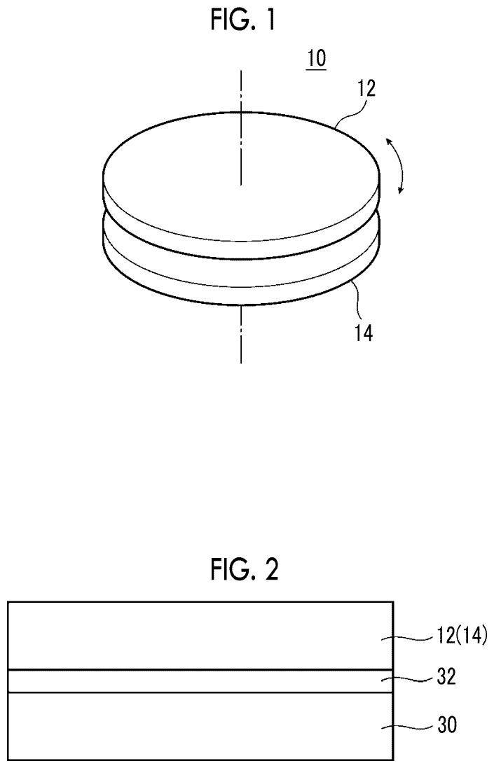

FIG. 1 is a perspective view conceptually showing an example of the lens device according to the embodiment of the present invention.

A lens device 10 shown in FIG. 1 includes a first liquid crystal layer 12 and a second liquid crystal layer 14 that are formed using a composition including a liquid crystal compound. As shown in FIG. 1, the first liquid crystal layer 12 and the second liquid crystal layer 14 are arranged in a thickness direction such that centers in an in-plane direction match with each other, and the first liquid crystal layer 12 and the second liquid crystal layer 14 are supported to be rotatable relative to each other around the center without changing a distance in the thickness direction (lamination direction). In the lens device 10 according to the embodiment of the present invention, any one of the first liquid crystal layer 12 or the second liquid crystal layer 14 may rotate, or both thereof may rotate independently.

In the following description, in a case where the first liquid crystal layer 12 and the second liquid crystal layer 14 do not need to be distinguished from each other, they will also be collectively referred to as the liquid crystal layer.

The first liquid crystal layer 12 and the second liquid crystal layer 14 are formed using a composition including a liquid crystal compound, and an optical axis derived from the liquid crystal compound is aligned in a vortex alignment pattern described below. In order to align the liquid crystal compound in the desired vortex alignment pattern, for example, as shown in FIG. 2, the first liquid crystal layer 12 and the second liquid crystal layer 14 are formed on an alignment film 32 formed on a support 30.

For use as the lens device 10, the lens device 10 may be in a state where the first liquid crystal layer 12 and the second liquid crystal layer are laminated on a support 30 and the alignment film 32. Alternatively, the lens device 10 may be in a state where, for example, only the alignment film 32 and the liquid crystal layers are laminated after peeling off the support 30. Alternatively, the lens device 10 may be in a state where, for example, only the liquid crystal layers are laminated after peeling off the support 30 and the alignment film 32.

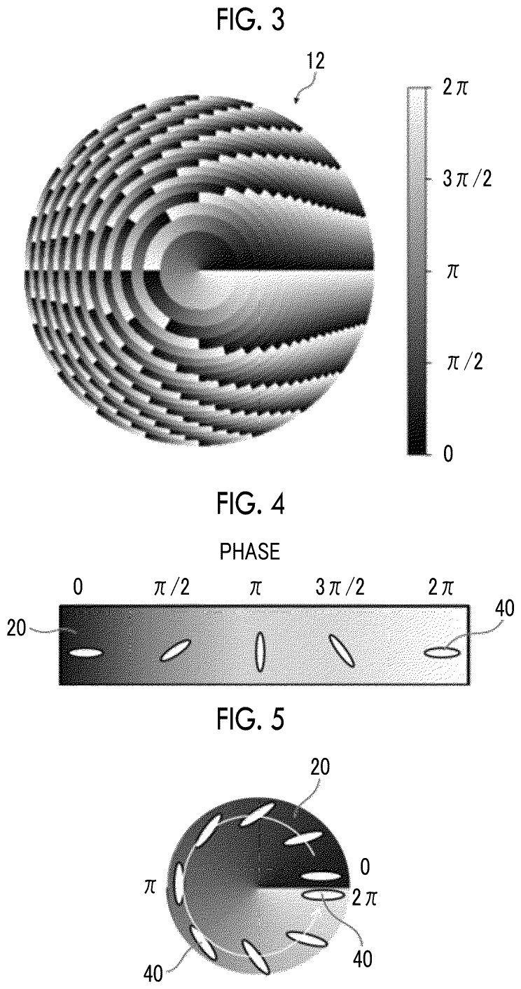

FIG. 3 is a plan view conceptually showing an example of the first liquid crystal layer 12. FIG. 3 is a diagram showing a phase where an orientation of the optical axis (slow axis) in each of fine regions in the first liquid crystal layer 12 is normalized by 0 to 2π and is visualized by gray scale where 0 is represented by black and 2π is represented by white.

As shown in FIG. 3, the first liquid crystal layer 12 includes a circular center portion and a plurality of annular portions that have centers matching with a center of the center portion and have different inner diameters provided in a radial direction of the center portion. In the example shown in FIG. 3, the first liquid crystal layer 12 includes the center portion and nineteen annular portions. The first annular portion from the center portion toward the radial direction is in contact with the center portion, and the second annular portion is in contact with the first annular portion. That is, the annular portions are concentrically formed in contact with each other in order such that centers thereof are the same as the center of the center portion.

As represented by the gray scale in FIG. 3, the phase (the orientation of the optical axis) of each of the center portion and the annular portions changes in the circumferential direction.

The phase will be described using FIG. 4.

FIG. 4 is a diagram showing a relationship between an orientation of an optical axis in each of the fine regions and a normalized phase. A state where an optical axis 40 is directed in a left-right direction in the drawing (the angle θ₁ of the optical axis is 0° in the polar coordinate expression described below) as in the leftmost optical axis 40 in FIG. 4 is defined as the phase 0, a state where the optical axis 40 is rotated counterclockwise by 180° as in the rightmost optical axis 40 in the drawing is defined as the phase 2π, and the phase is normalized according to the angle by which the optical axis 40 is rotated counterclockwise. For example, a state where the optical axis 40 is rotated counterclockwise by 45° (the second optical axis 40 from the left) is a phase π/2, a state where the optical axis 40 is rotated counterclockwise by 90° (the third optical axis 40 from the left) is a phase π, and a state where the optical axis 40 is rotated counterclockwise by 135° (the second optical axis 40 from the right) is a phase 3π/2. The change of the optical axis 40 is actually a continuous change, and the optical axis (liquid crystal compound) 40 that is aligned by an angle between the angles of the optical axes 40 in FIG. 4 is present between the optical axes 40. In addition, as can be seen from the drawing, the state of the optical axis in the phase 0 and the state of the optical axis in the phase 2π are the same.

For example, the phase of a center portion 20a of the first liquid crystal layer will be described using FIG. 5. FIG. 5 is a diagram showing the phase of the center portion 20a of the first liquid crystal layer 12 shown in FIG. 3. In FIG. 5, the phases of the first liquid crystal layer 12 (the center portion 20a) are represented by gray scale, and the orientations of the optical axes 40 are represented to be superimposed thereon. Basically, the orientation of the optical axis 40 in a fine region of the liquid crystal layer is an orientation of an optical axis derived from the liquid crystal compound. Accordingly, the optical axis 40 in FIG. 5 can also be called the optical axis of the liquid crystal compound. In a case where the liquid crystal compound is a rod-like liquid crystal compound, a major axis of the rod-like liquid crystal compound is the optical axis derived from the liquid crystal compound. In a case where the liquid crystal compound is a disk-like liquid crystal compound, an axis perpendicular to a disc plane of the disk-like liquid crystal compound is the optical axis.

As shown in FIG. 5, in case of being seen counterclockwise in the circumferential direction of the center portion 20a, the orientation of the optical axis (liquid crystal compound) 40 in the fine region is rotated counterclockwise. In the example shown in the drawing, while the center portion 20a rotates once from the position of 0 in the circumferential direction of the center portion 20a, the optical axis 40 rotates half of one turn, that is, the phase gradually changes from 0 to 2π.

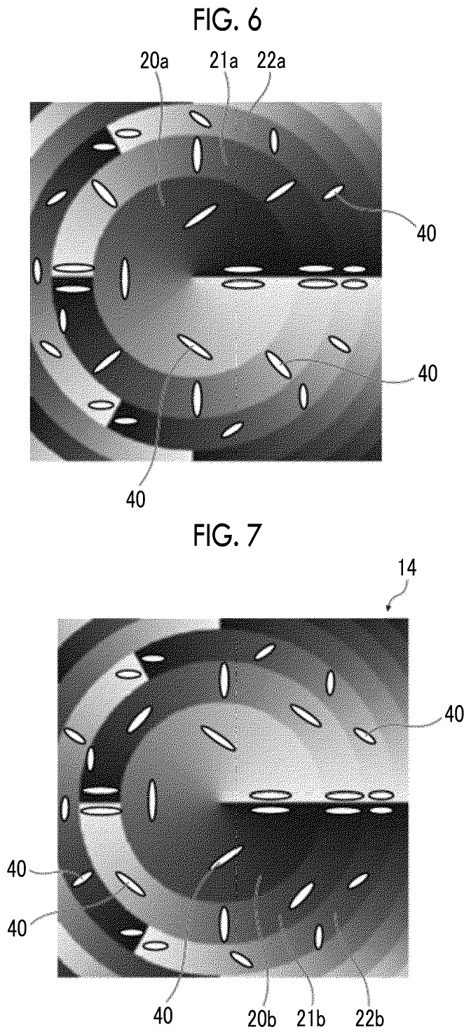

Next, the phase of the annular portion will be described using FIG. 6.

FIG. 6 is an enlarged view showing a part of the first liquid crystal layer 12 shown in FIG. 3, and is a diagram showing the phases of the center portion 20a and each of the annular portions.

As shown in FIG. 6, in the first annular portion (first annular portion) 21a from the center portion 20a toward the radial direction, in case of being seen counterclockwise in the circumferential direction of the first annular portion 21a, the orientation of the optical axis 40 in the fine region rotates once counterclockwise. That is, in the example shown in the drawing, in the first annular portion 21a, while the phase rotates once from the position of 0 in the circumferential direction of the first annular portion 21a, a phase change from 0 to 2π is repeated twice. That is, the number of phase changes in the first annular portion 21a is increased by one from that of the center portion 20a.

Next, in the second annular portion (second annular portion) 22a from the center portion 20a toward the radial direction, in case of being seen counterclockwise in the circumferential direction of the second annular portion 22a, the orientation of the optical axis 40 in the fine region rotates 1.5 times counterclockwise. That is, in the example shown in the drawing, in the second annular portion 22a, while the phase rotates once from the position of 0 in the circumferential direction of the second annular portion 22a, a phase change from 0 to 2π is repeated three times. That is, the number of phase changes in the second annular portion 22a is increased by one from that of the first annular portion 21a.

In the first liquid crystal layer 12, likewise, even in the third or subsequent annular portion from the center portion 20a toward the radial direction, in case of being seen counterclockwise in the circumferential direction, while the phase rotates once from the position of 0 in the circumferential direction of the annular portion, the phase change from 0 to 2π is repeated multiple times, and the number of repetitions of the phase change in one annular portion is increased by one from that of another annular portion inwardly adjacent thereto.

That is, in the n-th annular portion of the first liquid crystal layer 12 shown in FIG. 3, the phase change is repeated n+1 times.

In the present invention, the first liquid crystal layer 12 includes the center portion and the plurality of annular portions, and in each of the center portion and the plurality of annular portions, the phase change in the circumferential direction is repeated once or more, and a pattern where the phase change is repeated n+m times (m represents the number of phase changes in the center portion) in the n-th annular portion will be referred to as the vortex alignment pattern.

In the vortex alignment pattern, in polar coordinates of r and φ with respect to the center of the center portion 20a of the first liquid crystal layer 12 as an origin, the angle θ₁ [°] of the optical axis 40 in a region where φ is φ₁ is represented by Expression 3a.

$${θ}_{1} = {α}_{1} \times {φ}_{1} + {θ}_{0 n 1} \qquad Expression 3 a$$

Here, θ₀ₙ₁ [°] represents an angle of the optical axis of each of the center portion 20a and the annular portions at φ₁=0°. In the examples shown in FIGS. 3 and 6, in all of the center portion 20a and the annular portions, θ₀ₙ₁=0°.

A change in the angle θ₁ of the optical axis 40 in the center portion 20a is represented by α₁=m×0.5 in Expression 3a where m represents an integer of 1 or more. In addition, a change in the angle θ₁ of the optical axis in the n-th annular portion from the center portion 20a is represented by α₁=(m+n)×0.5 in Expression 3a.

m has the same definition as the number of phase changes in the center portion 20a, and in the examples shown in FIGS. 5 and 6, m=1. Accordingly, Expression 3a in the center portion 20a is α₁=1×0.5=0.5, and thus θ₁=0.5×φ₁+0°. Based on this expression, the angle θ₁ of the optical axis 40 in the center portion 20a is obtained as θ₁=0° in a region where φ₁=0°, θ₁=45° in a region where φ₁=90°, θ₁=90° in a region where φ₁=180°, θ₁=135° in a region where φ₁=270°, and θ₁=180° in a region where φ₁=360°. It can be seen that the same applies to the example shown in FIG. 5.

In addition, Expression 3a in the first annular portion 21a of the example shown in FIG. 6 is α₁=(1+1)×0.5=1, and thus θ₁=1×φ₁+0°. Based on this expression, the angle θ₁ of the optical axis 40 in the first annular portion 21a is obtained as θ₁=0° in a region where φ₁=0°, θ₁=90° in a region where φ₁=90°, θ₁=180° in a region where φ₁=180°, θ₁=270° in a region where φ₁=270°, and θ₁=360° in a region where φ₁=360°. It can be seen that the same applies to the first annular portion 21a of the example shown in FIG. 6.

In addition, Expression 3a in the second annular portion 22a of the example shown in FIG. 6 is α₁=(1+2)×0.5=1.5, and thus θ₁=1.5×φ₁+0°. Based on this expression, the angle θ₁ of the optical axis 40 in the second annular portion 22a is obtained as θ₁=0° in a region where φ₁=0°, θ₁=135° in a region where φ₁=90°, θ₁=270° in a region where φ₁=180°, θ₁=405°=45° in a region where φ₁=270°, and θ₁=540°=180° in a region where φ₁=360°. It can be seen that the same applies to the second annular portion 22a of the example shown in FIG. 6.

Even in the n-th annular portion, the angle θ₁ of the optical axis 40 is obtained from Expression 3a.

In the first liquid crystal layer 12 in the lens device according to the embodiment of the present invention, the angle θ₁ of the optical axis obtained in Expression 3a is satisfied in a range of ±3°.

That is, in polar coordinates of r and φ with respect to the center of the center portion of the first liquid crystal layer as an origin, in a case where a pattern where the angle θ₁ [°] of the optical axis of the first liquid crystal layer in a region where φ is φ₁ satisfies a relationship represented by Expression 3 is set as a vortex alignment pattern, the center portion of the first liquid crystal layer has a vortex alignment pattern where α₁=m×0.5 in a case where m represents an integer of 1 or more, and the n-th annular portion from the center portion of the first liquid crystal layer has a vortex alignment pattern where α₁=(m+n)×0.5.

$$\{ {α}_{1} \times {φ}_{1} + {θ}_{0 n 1} \} - 3 ° \leq {θ}_{1} \leq \{ {α}_{1} \times {φ}_{1} + {θ}_{0 n 1} \} + 3 ° \qquad Expression 3$$

(Here, θ₀ₙ₁ [°] represents an angle of the optical axis of each of the center portion and the annular portions at φ₁=0°.)

On the other hand, as in the first liquid crystal layer 12, the second liquid crystal layer 14 includes a circular center portion and a plurality of annular portions that have centers matching with a center of the center portion and have different inner diameters provided in a radial direction of the center portion, and has a vortex alignment pattern where a phase change in the circumferential direction of the center portion and each of the annular portions is opposite to that of the first liquid crystal layer 12.

The vortex alignment pattern of the second liquid crystal layer 14 will be described using FIG. 7.

FIG. 7 is an enlarged view showing a part of the second liquid crystal layer 14, and is a diagram showing the phases of the center portion 20b and each of the annular portions. In FIG. 7, the phases in the second liquid crystal layer 14 are represented by gray scale, and the orientations of the optical axes 40 are represented to be superimposed thereon.

As shown in FIG. 7, in case of being seen counterclockwise in the circumferential direction of the center portion 20b, the orientation of the optical axis (liquid crystal compound) 40 in the fine region is rotated clockwise. In the example shown in the drawing, while the center portion 20b rotates once from the position of 2π (0) in the circumferential direction of the center portion 20b, the optical axis 40 rotates half of one turn in a direction opposite to that of the first liquid crystal layer 12, that is, the phase gradually changes from 2π to 0. In other words, in the center portion 20b, the phase change from 0 to 2π occurs clockwise in the circumferential direction of the center portion 20b.

As shown in FIG. 7, in the first annular portion (first annular portion) 21b from the center portion 20b toward the radial direction, in case of being seen counterclockwise in the circumferential direction of the first annular portion 21b, the orientation of the optical axis 40 in the fine region rotates once clockwise. That is, in the example shown in the drawing, in the first annular portion 21b, while the phase rotates once from the position of 2π in the circumferential direction of the first annular portion 21b, a phase change from 2π to 0 is repeated twice. That is, the number of phase changes in the first annular portion 21b is increased by one from that of the center portion 20b. In addition, the phase change in the first annular portion 21b of the second liquid crystal layer 14 is opposite to the phase change in the first annular portion 21a of the first liquid crystal layer 12. In other words, in the first annular portion 21b, the phase change from 0 to 2π is repeated twice clockwise in the circumferential direction of the first annular portion 21b.

Next, in the second annular portion (second annular portion) 22b from the center portion 20b toward the radial direction, in case of being seen counterclockwise in the circumferential direction of the second annular portion 22b, the orientation of the optical axis 40 in the fine region rotates 1.5 times clockwise. That is, in the example shown in the drawing, in the second annular portion 22b, while the phase rotates once from the position of 2π in the circumferential direction of the second annular portion 22b, a phase change from 2π to 0 is repeated three times. That is, the number of phase changes in the second annular portion 22b is increased by one from that of the first annular portion 21b. In addition, the phase change in the second annular portion 22b of the second liquid crystal layer 14 is opposite to the phase change in the second annular portion 22a of the first liquid crystal layer 12. In other words, in the second annular portion 22b, the phase change from 0 to 2π is repeated three times clockwise in the circumferential direction of the second annular portion 22b.

In the second liquid crystal layer 14, likewise, even in the third or subsequent annular portion from the center portion 20b toward the radial direction, in case of being seen counterclockwise in the circumferential direction, while the phase rotates once from the position of 2π in the circumferential direction of the annular portion, the phase change from 2π to 0 is repeated multiple times, and the number of repetitions of the phase change in one annular portion is increased by one from that of another annular portion inwardly adjacent thereto.

That is, in the n-th annular portion of the second liquid crystal layer 14 shown in FIG. 7, the phase change is repeated n+1 times.

This way, the second liquid crystal layer 14 includes the center portion and the plurality of annular portions, and in each of the center portion and the plurality of annular portions, the phase change in direction opposite to that of the first liquid crystal layer 12 is repeated once or more, and the phase change is repeated n+m times (m represents the number of phase changes in the center portion) in the n-th annular portion.

As in the first liquid crystal layer 12, in the above-described vortex alignment pattern, in polar coordinates of r and φ with the center of the center portion 20b of the second liquid crystal layer 14 as an origin, the angle θ₂ [°] of the optical axis 40 in a region where φ is φ₂ is represented by Expression 4a.

$${θ}_{2} = {α}_{2} \times {φ}_{2} + {θ}_{0 n 2} \qquad Expression 4 a$$

Here, θ₀ₙ₂ [°] represents an angle of the optical axis of each of the center portion 20b and the annular portions at φ₂=0°. In the examples shown in FIG. 7, in all of the center portion 20b and the annular portions, θ₀ₙ₂=0°.

A change in the angle θ₂ of the optical axis 40 in the center portion 20b is represented by α₂=−(m×0.5) in Expression 4a where m represents an integer of 1 or more. In addition, a change in the angle θ₂ of the optical axis in the n-th annular portion from the center portion 20b is represented by α₂=−(m+n)×0.5 in Expression 4a.

m has the same definition as the number of phase changes in the center portion 20b, and in the examples shown in FIG. 7, m=1. Accordingly, Expression 4a in the center portion 20b is α₂=−1×0.5=−0.5, and thus θ₂=−0.5×φ₂+0°. Based on this expression, the angle θ₂ of the optical axis 40 in the center portion 20b is obtained as θ₂=0° (=180°) in a region where φ₂=0°, θ₂=−45° (=135°) in a region where φ₂=90°, θ₂=−90°=) 90°) in a region where φ₂=180°, θ₂=−135° (=45°) in a region where φ₂=270°, and θ₂=−180° (=0°) in a region where φ₂=360°. It can be seen that the same applies to the example shown in FIG. 5.

In addition, Expression 4a in the first annular portion 21b of the example shown in FIG. 7 is α₂=−(1+1)×0.5=−1, and thus θ₂=1×φ₂+0°. Based on this expression, the angle θ₂ of the optical axis 40 in the first annular portion 21b is obtained as θ₂=0° (=180°) in a region where φ₂=0°, θ₂=−90°=) 90°) in a region where φ₂=90°, θ₂=−180° (=0°) in a region where φ₂=180°, θ₂=−270 (=90°) in a region where φ₂=270°, and θ₂=−360° (=0°) in a region where φ₂=360°. It can be seen that the same applies to the first annular portion 21b of the example shown in FIG. 7.

In addition, Expression 4a in the second annular portion 22b of the example shown in FIG. 7 is α₂=−(1+2)×0.5=−1.5, and thus θ₂=−1.5×φ₂+0°. Based on this expression, the angle θ₂ of the optical axis 40 in the second annular portion 22b is obtained as θ₂=0° (=180°) in a region where φ₂=0°, θ₂=−135° (=45°) in a region where φ₂=90°, θ₂=−270° (=90°) in a region where φ₂=180°, θ₂=−405°=−45° (=135°) in a region where φ₂=270°, and θ₂=−540°=−180° (=0°) in a region where φ₂=360°. It can be seen that the same applies to the second annular portion 22b of the example shown in FIG. 7.

Even in the n-th annular portion, the angle θ₂ of the optical axis 40 is obtained from Expression 4a.

In the second liquid crystal layer 14 in the lens device according to the embodiment of the present invention, the angle θ₂ of the optical axis obtained in Expression 4a is satisfied in a range of ±3°.

That is, in polar coordinates of r and φ with respect to the center of the center portion of the second liquid crystal layer as an origin, in a case where a pattern where an angle θ₂ [°] of the optical axis of the second liquid crystal layer in a region where φ is φ₂ satisfies a relationship represented by Expression 4 is set as a vortex alignment pattern, the center portion of the second liquid crystal layer has a vortex alignment pattern where α₂=m×0.5 in a case where m represents an integer of 1 or more, and the n-th annular portion from the center portion of the second liquid crystal layer has a vortex alignment pattern where α₂=m+n×0.5.

$$\{ {α}_{2} \times {φ}_{2} + {θ}_{0 n 2} \} - 3 ° \leq {θ}_{2} \leq \{ {α}_{2} \times {φ}_{2} + {θ}_{0 n 2} \} + 3 ° \qquad Expression 4$$

(Here, θ₀ₙ₂ [°] represents an angle of the optical axis of each of the center portion and the annular portions at φ₂=0°).

In the vortex alignment pattern, an absolute value of α₁ or α₂ matches with the number of times the optical axis 40 rotates in case of being seen counterclockwise in the circumferential direction. In addition, the plus or minus sign of α₁ or α₂ represents the rotation direction of the optical axis 40. α₁ or α₂ represents the order of the vortex alignment pattern.

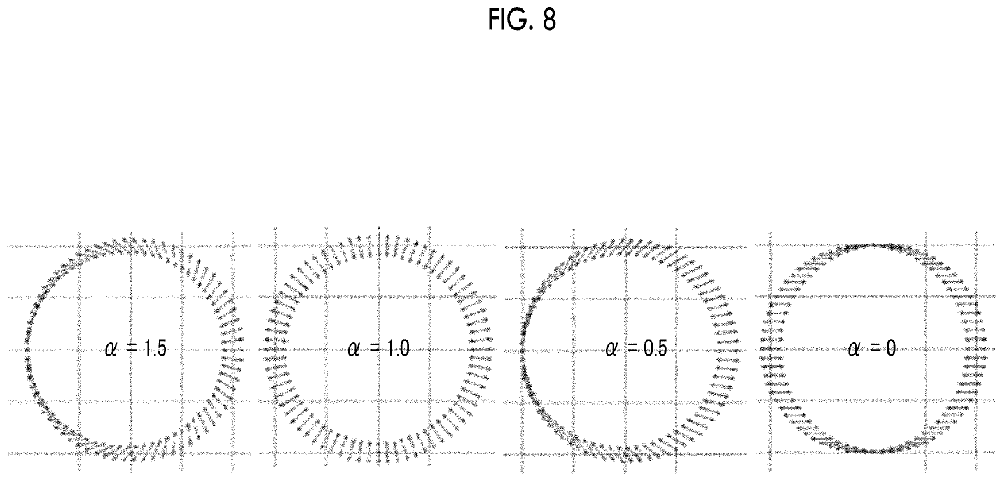

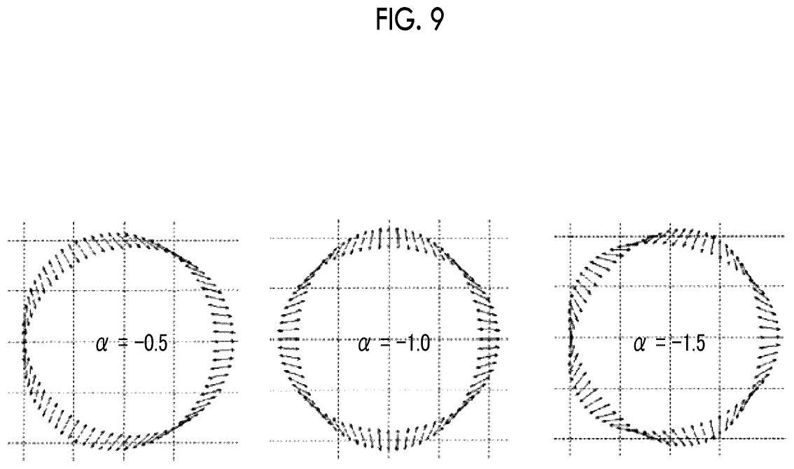

FIG. 8 shows a change of the optical axis in detail in a case where the order α is 0, 0.5, 1.0, or 1.5, and FIG. 9 shows a change of the optical axis in detail in a case where the order α is −0.5, 1.0, or 1.5.

Here, an inner diameter rᵢₙ₋ₙ₁ and an outer diameter rₒᵤₜ₋ₙ₁ of an n-th annular portion from the center portion of the first liquid crystal layer and an inner diameter rᵢₙ₋ₙ₂ and an outer diameter rₒᵤₜ₋ₙ₂ of an n-th annular portion from the center portion of the second liquid crystal layer satisfy relationships represented by Expression 1 and Expression 2.

$$0.9 \times {r}_{i n - n 1} \leq {r}_{i n - n 2} \leq 1.1 \times {r}_{i n - n 1} \qquad Expression 1$$

$$0.9 \times {r}_{out - n 1} \leq {r}_{out - n 2} \leq 1.1 \times {r}_{out - n 1} \qquad Expression 2$$

That is, in a case where the first liquid crystal layer 12 and the second liquid crystal layer 14 are arranged in the thickness direction such that the centers of the center portions match with each other, the center portions overlap each other and the n-th annular portions overlap each other in case of being seen from the thickness direction. As a result, an area where the laminate of the first liquid crystal layer and the second liquid crystal layer functions as a lens can be maintained.

The inner diameter rᵢₙ₋ₙ₁ and the outer diameter rₒᵤₜ₋ₙ₁ of an n-th annular portion from the center portion of the first liquid crystal layer and the inner diameter rᵢₙ₋ₙ₂ and the outer diameter rₒᵤₜ₋ₙ₂ of an n-th annular portion from the center portion of the second liquid crystal layer is preferably satisfy relationships represented by Expression 1a and Expression 2a, and more preferably satisfy relationships represented by Expression 1b and Expression 2b.

$$0.95 \times {r}_{i n - n 1} \leq {r}_{i n - n 2} \leq 1.05 \times {r}_{i n - n 1} \qquad Expression 1 a$$

$$0.95 \times {r}_{out - n 1} \leq {r}_{out - n 2} \leq 1.05 \times {r}_{out - n 1} \qquad Expression 2 a$$

$$0.97 5 \times {r}_{i n - n 1} \leq {r}_{i n - n 2} \leq 1.025 \times {r}_{i n - n 1} \qquad Expression 1 b$$

$$0.975 \times {r}_{out - n 1} \leq {r}_{out - n 2} \leq 1.025 \times {r}_{ou𝔠t - n 1} \qquad Expression 2 b$$

In addition, based on Expression 3 and Expression 4, the order of the center portion 20a and the n-th annular portion of the first liquid crystal layer 12 are the same as the order of the center portion 20b and the n-th annular portion of the second liquid crystal layer 14. That is, the number of repetitions of phase changes in the center portion 20a and the n-th annular portion of the first liquid crystal layer 12 is the same as the number of repetitions of phase changes in the center portion 20b and the n-th annular portion of the second liquid crystal layer 14.

In the lens device including the first liquid crystal layer 12 and the second liquid crystal layer 14, the focal length as a lens is variable by rotating the first liquid crystal layer 12 and the second liquid crystal layer 14 relative to each other around the center without changing the distance between the first liquid crystal layer 12 and the second liquid crystal layer 14.

This point will be described using a lens device including the first liquid crystal layer 12 shown in FIGS. 3 and 6 and the second liquid crystal layer 14 shown in FIG. 7 as an example.

By using an angle at which θ₁ of the center portion 20a of the first liquid crystal layer 12 is 0° (that is, the phase is 0) as a reference line of the first liquid crystal layer 12 and using an angle at which θ₂ of the center portion 20b of the second liquid crystal layer 14 is 0° (that is, the phase is 0=2π) as a reference line of the second liquid crystal layer 14, an angle between the reference line of the first liquid crystal layer 12 and the reference line of the second liquid crystal layer 14 is obtained as a relative angle between the first liquid crystal layer 12 and the second liquid crystal layer 14. In a case where the first liquid crystal layer 12 and the second liquid crystal layer 14 disposed to overlap each other are seen from the second liquid crystal layer 14 side, the relative angle between the first liquid crystal layer 12 and the second liquid crystal layer 14 is represented by −180° to 180°, in which the positive sign represents the counterclockwise direction and the negative sign represents the clockwise direction regarding the rotation direction of the reference line of the second liquid crystal layer 14 with respect to the reference line of the first liquid crystal layer 12.

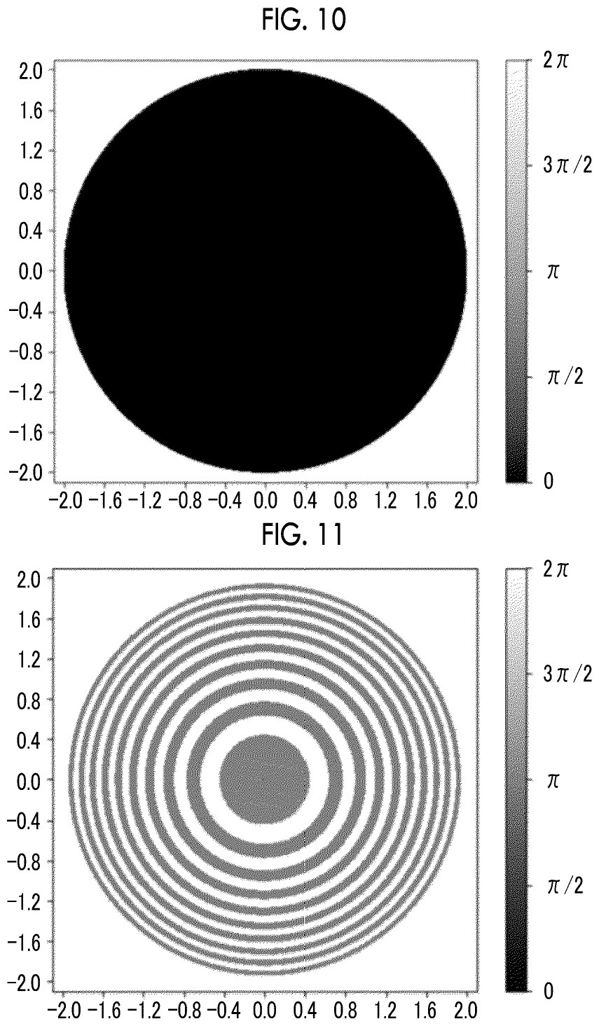

In a case where the relative angle between the first liquid crystal layer 12 and the second liquid crystal layer 14 is 0°, the phase as the laminate of the first liquid crystal layer 12 and the second liquid crystal layer 14 is in a state conceptually shown in FIG. 10.

In a case where the phase is in this state, that is, the phase of the entire surface is 0, the laminate of the first liquid crystal layer 12 and the second liquid crystal layer 14 allows transmission of light without diffracting the light.

In a case where the relative angle between the first liquid crystal layer 12 and the second liquid crystal layer 14 is 180°, the phase as the laminate of the first liquid crystal layer 12 and the second liquid crystal layer 14 is in a state conceptually shown in FIG. 11.

Even in a case where the phase is in this state, that is, the phase distribution includes only 0, π, and 2π, the laminate of the first liquid crystal layer 12 and the second liquid crystal layer 14 allows transmission of light without diffracting the light.

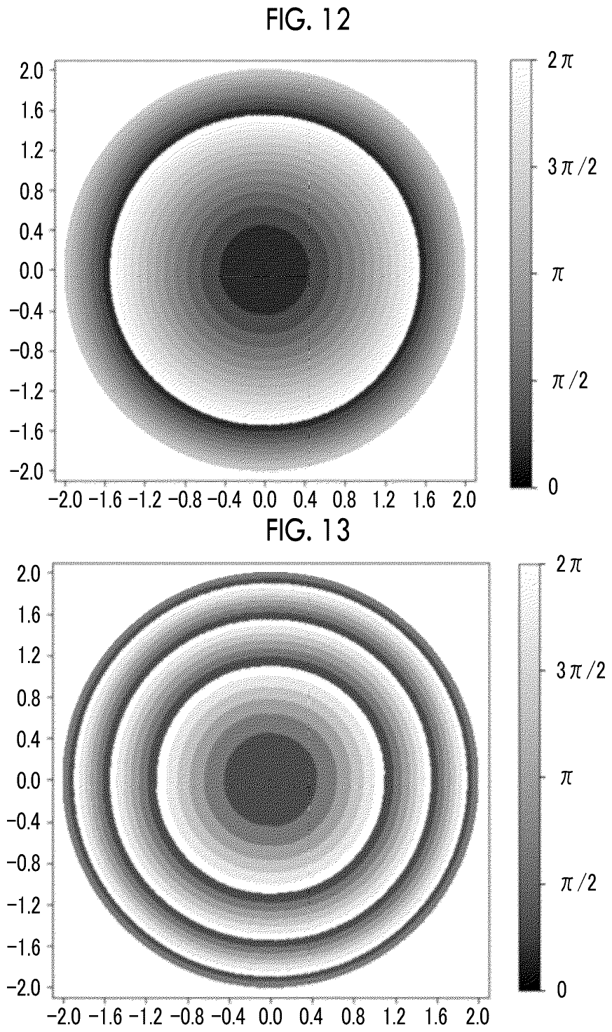

Next, for example, in a case where the relative angle between the first liquid crystal layer 12 and the second liquid crystal layer 14 is 30°, the phase as the laminate of the first liquid crystal layer 12 and the second liquid crystal layer 14 is in a state conceptually shown in FIG. 12.

In this phase state, the phase is uniform in each of regions corresponding to the center portion and the annular portions, and the phase varies between adjacent regions. That is, the regions having different phases are concentrically provided. In a case where this phase state is seen in the radial direction of each of the orientations from the center, the phase continuously changes from the center toward the outer side. That is, it can be said that the example shown in FIG. 12 has the pattern where the optical axis changes while continuously rotating from the center toward the outer side. Assuming that the direction in which the optical axis changes while continuously rotating is an arrangement axis, it can be said that the example shown in FIG. 12 has the arrangement axis in a radial shape from the center toward the outer side.

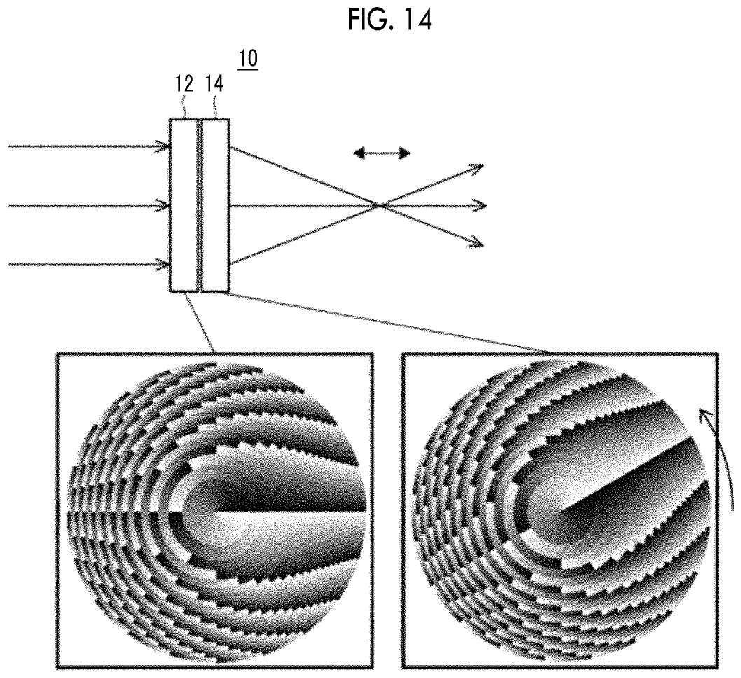

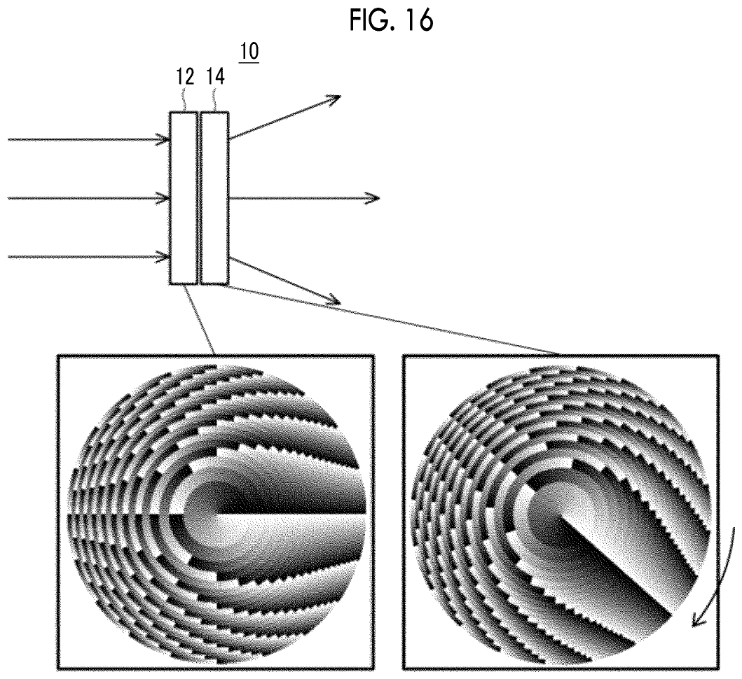

In a case where the laminate including the first liquid crystal layer 12 and the second liquid crystal layer 14 has the pattern in which the optical axis continuously changes while rotating, circularly polarized light incident into the laminate is diffracted in an orientation direction along the arrangement axis. In this case, the diffraction direction of right circularly polarized light is opposite to that of left circularly polarized light. Accordingly, as shown in FIG. 12, in the phase state including the arrangement axis in a radial shape from the center toward the outer side, the laminate acts as a condenser lens (convex lens) that converges light as in the example shown in FIG. 14 for one incident circularly polarized light, and acts as a divergent lens (concave lens) that diverges light as in the example shown in FIG. 16 for the other incident circularly polarized light.

In addition, for example, in a case where the relative angle between the first liquid crystal layer 12 and the second liquid crystal layer 14 is 60°, the phase as the laminate of the first liquid crystal layer 12 and the second liquid crystal layer 14 is in a state conceptually shown in FIG. 13.

In this phase state, as in FIG. 12, the phase is uniform in each of regions corresponding to the center portion and the annular portions, and the phase varies between adjacent regions. That is, the regions having different phases are concentrically provided. In addition, it can be said that the example shown in FIG. 13 has the pattern where the optical axis changes while continuously rotating from the center toward the outer side and the arrangement axis is provided in the radial shape.

In addition, in a case where the relative angle between the first liquid crystal layer 12 and the second liquid crystal layer 14 is 60° as shown in FIG. 13, a period of the phase change along the arrangement axis, that is, a single period over which the optical axis rotates by 180° is shorter than that of a case where the relative angle is 30°. As the single period decreases, the diffraction angle of light increases. Therefore, in a case where the relative angle between the first liquid crystal layer 12 and the second liquid crystal layer 14 is 60°, the focal length of the condenser lens that converges light is shorter than that in a case where the relative angle is 30°. The focal length is the shortest in a case where the relative angle between the first liquid crystal layer 12 and the second liquid crystal layer 14 is 90°.

This way, the focal length of the laminate that acts as a lens can be changed by changing the relative angle between the first liquid crystal layer 12 and the second liquid crystal layer 14. For example, for the circularly polarized light for which the laminate of the first liquid crystal layer 12 and the second liquid crystal layer 14 acts as the condenser lens, the focal length for the condenser lens can be changed by changing the relative angle as shown in FIG. 14. For the circularly polarized light for which the laminate of the first liquid crystal layer 12 and the second liquid crystal layer 14 acts as the divergent lens, the focal length for the divergent lens can be changed by changing the relative angle. In this case, as the relative angle between the first liquid crystal layer 12 and the second liquid crystal layer 14 increases in a range between 0° to 90°, the focal length can be shortened. In addition, as the relative angle increases in a range between 90° to 180°, the focal length can be lengthened.

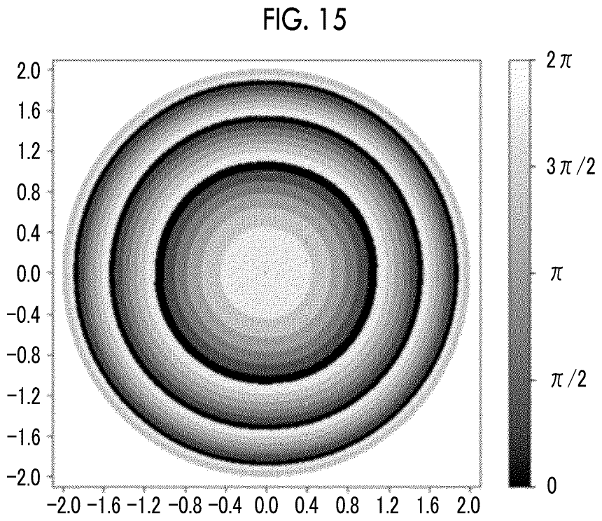

On the other hand, in a case where the relative angle between the first liquid crystal layer 12 and the second liquid crystal layer 14 is −60°, the phase as the laminate of the first liquid crystal layer 12 and the second liquid crystal layer 14 is in a state conceptually shown in FIG. 15.

In this phase state, as in FIG. 12, the phase is uniform in each of regions corresponding to the center portion and the annular portions, and the phase varies between adjacent regions. That is, the regions having different phases are concentrically provided. In addition, it can be said that the example shown in FIG. 15 has the pattern where the optical axis changes while continuously rotating from the center toward the outer side and the arrangement axis is provided in the radial shape.

In addition, in a case where the relative angle between the first liquid crystal layer 12 and the second liquid crystal layer 14 is −60° as shown in FIG. 15, the orientation of the phase change along the arrangement axis, that is, the rotation direction of the optical axis along the arrangement axis is opposite to that in a case where the relative angle is 60°. In a case where the rotation direction of the optical axis along the arrangement axis is reversed, the diffraction direction in the orientation direction along the arrangement axis is reversed with respect to incident circularly polarized light. Accordingly, the circularly polarized light for which the laminate acts as the condenser lens and the circularly polarized light for which the laminate acts as the divergent lens are opposite to that in a case where the relative angle is 60°.

Even in this case, as in the case of FIGS. 13 and 14, as the single period over which the optical axis rotates by 180° decreases, the diffraction angle of light increases. Therefore, in a case where the relative angle between the first liquid crystal layer 12 and the second liquid crystal layer 14 is −60°, the focal length is shorter than that in a case where the relative angle is −30°. In addition, the focal length is the shortest in a case where the relative angle is −90°.

This way, even in a case where the relative angle between the first liquid crystal layer 12 and the second liquid crystal layer 14 is changed in the negative direction, the focal length of the laminate that acts as a lens can be changed. For example, for the circularly polarized light for which the laminate of the first liquid crystal layer 12 and the second liquid crystal layer 14 acts as the divergent lens, (that is, the circularly polarized light that is converged in a case where the relative angle is positive), the focal length for the divergent lens can be changed by changing the relative angle as shown in FIG. 16. In addition, for the circularly polarized light for which the laminate of the first liquid crystal layer 12 and the second liquid crystal layer 14 acts as the condenser lens, the focal length for the condenser lens can be changed by changing the relative angle. In this case, as the relative angle between the first liquid crystal layer 12 and the second liquid crystal layer 14 increases in a range between 0° to −90°, the focal length can be shortened. In addition, as the relative angle increases in a range between −90° to −180° (=180°), the focal length can be lengthened.

As described above, as a thin lens device where the focal length is variable, there is disclosed an Alvarez lens where liquid crystal films having a lens action are translated relative to each other in an in-plane direction to change the focal length of the lens. However, in the configuration where the two liquid crystal films are translated in the in-plane direction, the thickness of the lens in the optical axis direction can be reduced, but the size of a region acting as the lens is less than that of the liquid crystal film. In addition, a space for translating the two liquid crystal films is required. Therefore, the size in the in-plane direction increases, and there is a problem in that a reduction in size is not sufficient.

On the other hand, in the lens device according to the embodiment of the present invention, as described above, the focal length is variable by rotating the two liquid crystal layers relative to each other without changing the distance between the two liquid crystal layers in the thickness direction. Therefore, the size of the region that substantially acts as a region can be made substantially the same as the size of the two liquid crystal layers. Accordingly, a thin lens device where the size in the in-plane direction is also small and the focal length is variable can be obtained.

Here, a mechanism that rotates the first liquid crystal layer 12 and the second liquid crystal layer 14 relative to each other is not particularly limited, and various well-known rotation mechanisms such as an electric motor, an ultrasonic motor, or a rack-and-pinion mechanism can be appropriately used.

In addition, in the lens device 10 according to the embodiment of the present invention, in a case where the distance between the first liquid crystal layer 12 and the second liquid crystal layer 14 is excessively long, a part of light transmitted through the center portion and each of the annular portions of the first liquid crystal layer 12 is likely to be incident into the other regions instead of the center portion and each of the annular portions of the second liquid crystal layer 14 corresponding to the first liquid crystal layer 12. In this case, there is a concern that the lens device 10 cannot appropriately exhibit the above-described lens action. Accordingly, it is preferable that the distance between the first liquid crystal layer 12 and the second liquid crystal layer 14 is as short as possible in a range where the first liquid crystal layer 12 and the second liquid crystal layer 14 can rotate relative to each other.

Specifically, the distance between the first liquid crystal layer 12 and the second liquid crystal layer 14 is preferably 10 mm or less, more preferably 1 mm or less, and still more preferably 0.1 mm or less.

In addition, the diameter of the center portion and the inner diameter, the outer diameter, and the width in the radial direction and the like of each of the annular portions in the first liquid crystal layer 12 and the second liquid crystal layer 14 are not particularly limited, and may be appropriately set depending on the range of the focal length required as the lens device 10, the lens diameter, the size of a light source, the size of the device to be used, and the like.

The diameter of the center portion and the width in the radial direction of each of the annular portions in the first liquid crystal layer 12 and the second liquid crystal layer 14 are preferably 100 mm or less, more preferably 10 mm or less, and still more preferably 5 mm or less.

In addition, it is preferable that the width in the radial direction of each of the annular portions in the first liquid crystal layer 12 and the second liquid crystal layer 14 decreases in order from the center portion toward the outer side. As a result, in the phase state of the laminate of the first liquid crystal layer 12 and the second liquid crystal layer 14 in a case where the relative angle between the first liquid crystal layer 12 and the second liquid crystal layer 14 is an angle at which the lens action occurs, the single period over which the optical axis rotates by 180° in the direction along the above-described arrangement axis gradually decreases from the center toward the outer side. As the single period decreases, the diffraction angle of light increases. Accordingly, by making the single period to gradually decrease from the center toward the outer side along the arrangement axis, the power of condensing or diverging light by the laminate of the first liquid crystal layer 12 and the second liquid crystal layer 14 can be further improved, and the performance as a convex lens or a concave lens can be improved.

In addition, in the examples shown in FIGS. 3, 6, 7, and the like, in the center portions of the first liquid crystal layer 12 and the second liquid crystal layer 14, while the phase rotates once in the circumferential direction of the center portion, the phase change from 0 to 2π occurs once. That is, m for determining α₁ and α₂ in Expression 3 and Expression 4 is set as 1, but the present invention is not limited thereto. The number of phase changes in the circumferential direction in the center portion, that is, m may be 2 or more. In a case where m is 2 or more, the number of phase changes in the circumferential direction in the n-th annular portion of the first liquid crystal layer 12 and the second liquid crystal layer 14 is m+n.

In addition, the orders α of the annular portions are at intervals of 0.5 from the center portion toward the outer side, but the present invention is not limited thereto. The orders α may be at intervals of 1.0, 1.5, or the like. In addition, the amount of change of the order of the annular portions adjacent to each other does not need to be fixed. However, from the viewpoint that the performance as a lens can be improved, it is preferable that the orders α of the annular portions from the center portion toward the outer side are at intervals of 0.5.

Here, in the above-described example, in the first liquid crystal layer 12, the orientation direction in which the optical axis is parallel to the radial direction in the center portion 20a matches with the orientation direction in which the optical axis is parallel to the radial direction in each of the annular portions. In addition, in the second liquid crystal layer 14, the orientation direction in which the optical axis is parallel to the radial direction in the center portion 20b matches with the orientation direction in which the optical axis is parallel to the radial direction in each of the annular portions. In other words, in a case where an azimuthal angle at which the optical axis is parallel to the radial direction in the n-th annular portion from the center portion with respect to an azimuthal angle at which the optical axis is parallel to the radial direction in the center portion 20a of the first liquid crystal layer 12 is represented by φₙ₁ and an azimuthal angle at which the optical axis is parallel to the radial direction in the n-th annular portion from the center portion with respect to an azimuthal angle at which the optical axis is parallel to the radial direction in the center portion 20b of the second liquid crystal layer 14 is represented by φₙ₂, φₙ₁=0° and φₙ₂=0° are satisfied.

However, the present invention is not limited to this example. In the first liquid crystal layer 12, the azimuthal angles φₙ₁ at which the optical axis is parallel to the radial direction in the annular portions may be different from each other. In addition, in the second liquid crystal layer 14, the azimuthal angles φₙ₂ at which the optical axis is parallel to the radial direction in the annular portions may be different from each other. That is, for example, in the first liquid crystal layer 12, φₙ₁=φ₁₁ in the first annular portion, φₙ₁=φ₂₁ in the second annular portion, and φₙ₁=φ₃₁ in the third annular portion, . . . may be different from each other. In addition, in the second liquid crystal layer 14, φₙ₂=φ₁₂ in the first annular portion, φₙ₂=φ₂₂ in the second annular portion, and φₙ₂=φ₃₂ in the third annular portion, . . . may be different from each other.

In addition, in each of the first liquid crystal layer 12 and the second liquid crystal layer 14, in a case where the azimuthal angles (φₙ₁, φₙ₂) at which the optical axis is parallel to the radial direction in the annular portions are different from each other, it is preferable that the orientation φₙ₁ at which the optical axis is parallel to the radial direction in the n-th annular portion of the first liquid crystal layer 12 and the orientation φₙ₂ at which the optical axis is parallel to the radial direction in the n-th annular portion of the second liquid crystal layer 14 satisfy φₙ₁=φₙ₂. That is, for example, it is preferable that φ₁₁ in the first annular portion of the first liquid crystal layer 12 and φ₁₂ in the first annular portion of the second liquid crystal layer 14 are the same, φ₂₁ in the second annular portion of the first liquid crystal layer 12 and φ₂₂ in the second annular portion of the second liquid crystal layer 14 are the same, and φ₃₁ in the third annular portion of the first liquid crystal layer 12 and φ₃₂ in the third annular portion of the second liquid crystal layer 14 are the same.

With the configuration where φₙ₁ of the n-th annular portion of the first liquid crystal layer 12 and φₙ₂ of the n-th annular portion of the second liquid crystal layer 14 satisfy φₙ₁=φₙ₂, in a case where the relative angle between the first liquid crystal layer 12 and the second liquid crystal layer 14 is 0°, the laminate (lens device) of the first liquid crystal layer 12 and the second liquid crystal layer 14 can allow transmission of light without diffracting the light. That is, by changing the relative angle between the first liquid crystal layer 12 and the second liquid crystal layer 14, the laminate (lens device) of the first liquid crystal layer 12 and the second liquid crystal layer 14 can switch between a state where the laminate functions as a condenser lens or a divergent lens and a state where the laminate allows transmission without diffracting the light.

The above-described lens device 10 including the first liquid crystal layer 12 and the second liquid crystal layer may function as an axicon lens, may function as a spherical lens, or may function as an aspherical lens.

The lens as which the lens device 10 functions is determined depending on the width of each of the annular portions of the first liquid crystal layer 12 and the second liquid crystal layer 14.

For example, in a case where the lens device functions as an axicon lens, the width of each of the annular portions of the first liquid crystal layer 12 and the second liquid crystal layer 14 may be fixed.

In addition, in a case where the lens device functions as a spherical lens, the width of each of the annular portions of the first liquid crystal layer 12 and the second liquid crystal layer 14 may be appropriately determined to be inversely proportional to the ½ power of the width of the first annular portion.

### <Method of Forming Liquid Crystal Layer Having Vortex Alignment Pattern>

The liquid crystal layer having the vortex alignment pattern can be formed by applying a liquid crystal composition including a liquid crystal compound to an alignment film for aligning the liquid crystal compound in the predetermined vortex alignment pattern, forming a liquid crystal phase where an orientation of an optical axis derived from the liquid crystal compound is aligned in the vortex alignment pattern, and immobilizing the liquid crystal phase in a layer shape.

In addition, in the present invention, the liquid crystal layer may be formed by application of multiple layers. The application of the multiple layers refers to a method of forming the liquid crystal layer by repeating the following processes until a desired thickness is obtained, the processes including: forming a first liquid crystal immobilized layer by applying the liquid crystal composition for forming the first layer to the alignment film, heating the liquid crystal composition, cooling the liquid crystal composition, and irradiating the liquid crystal composition with ultraviolet light for curing; and forming a second or subsequent liquid crystal immobilized layer by applying the liquid crystal composition for forming the second or subsequent layer to the formed liquid crystal immobilized layer, heating the liquid crystal composition, cooling the liquid crystal composition, and irradiating the liquid crystal composition with ultraviolet light for curing as described above.

### (Support)

As a support that supports the alignment film and the optically-anisotropic layer, various sheet-shaped materials (films or plate-shaped materials) can be used as long as they can support the alignment film and the optically-anisotropic layer.

A transmittance of the support with respect to light to be diffracted is preferably 50% or more, more preferably 70% or more, and still more preferably 85% or more.

The thickness of the support is not particularly limited and may be appropriately set depending on the use of the lens device, a material for forming the support, and the like in a range where the alignment film and the liquid crystal layer can be supported.

The thickness of the support is preferably in a range of 1 to 1000 μm, more preferably in a range of 3 to 250 μm, and still more preferably in a range of 5 to 150 μm.

The support may have a monolayer structure or a multi-layer structure.

In a case where the support has a monolayer structure, examples thereof include supports formed of glass, triacetyl cellulose (TAC), polyethylene terephthalate (PET), polycarbonates, polyvinyl chloride, acryl, polyolefin, and the like. In a case where the support has a multi-layer structure, examples thereof include a support including: one of the above-described supports having a monolayer structure that is provided as a substrate; and another layer that is provided on a surface of the substrate.

### (Alignment Film)

The alignment film is formed on the surface of the support.

The alignment film is an alignment film for aligning the liquid crystal compound in a predetermined vortex alignment pattern during the formation of the liquid crystal layer.

The alignment film can be suitably used as a so-called photo-alignment film obtained by irradiating a photo-alignment material with polarized light or non-polarized light. That is, in the present invention, a photo-alignment film that is formed by applying a photo-alignment material to the support is suitably used as the alignment film.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the alignment film that can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking polyester, a cinnamate compound, or a chalcone compound is suitably used.

The thickness of the alignment film 32 is not particularly limited. The thickness with which a required alignment function can be obtained may be appropriately set depending on the material for forming the alignment film 32.

The thickness of the alignment film 32 is preferably 0.01 to 5 μm and more preferably 0.05 to 2 μm.

In the present invention, a suitable exposure method of the alignment film for forming the vortex alignment pattern is a method of exposing the alignment film using a direct drawing method.

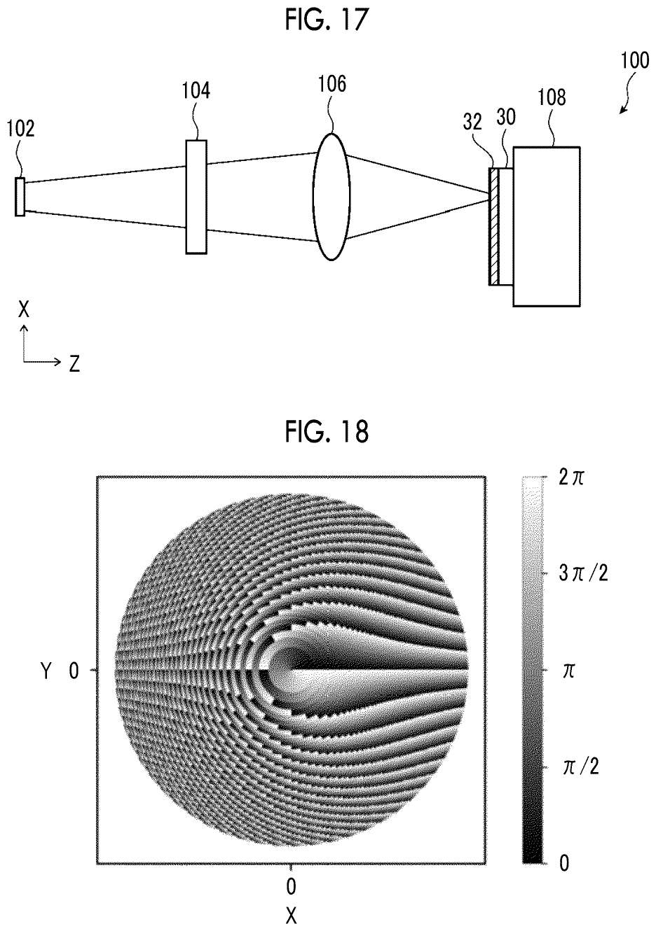

FIG. 17 is a diagram conceptually showing an example of an exposure device that exposes the alignment film.

An exposure device 100 shown in FIG. 17 includes a light source 102, a λ/2 plate 104 that changes a polarization direction of light emitted from the light source 102, a lens 106 that is disposed on an optical path, and an XY stage 108. The exposure device 100 directly focuses a linearly polarized light beam onto the alignment film, and scans the focusing position to draw an alignment pattern on the alignment film.

The light source 102 includes a laser and a linearly polarizing plate, and emits linearly polarized light. The emitted linearly polarized light is incident into the λ/2 plate 104. The λ/2 plate 104 is rotatably attached, and is rotatable around an axis perpendicular to an XY plane of the XY stage 108. The λ/2 plate 104 rotates around the axis perpendicular to the XY plane to convert the polarization direction of the incident linearly polarized light into any direction. The lens 106 focuses the linearly polarized light transmitted through the λ/2 plate 104 on the surface of the alignment film 32 disposed on the XY stage 108. The support 30 including the alignment film 32 is disposed on the XY stage 108, and the alignment film 32 (support 30) is moved in the X direction and/or the Y direction to change the position on the surface of the alignment film 32 where the light is focused. That is, the XY stage 108 scans the surface of the alignment film 32 with the light.

The rotation of the λ/2 plate 104 and the movement of the XY stage 108 are controlled by, for example, a computer to associate the position on the surface of the alignment film 32 where the light is focused and the polarization direction of the light with each other. As a result, a desired alignment pattern can be formed on the vortex alignment pattern.

The irradiation of the light beam from the light source 102, the rotation of the λ/2 plate 104, and the movement of the XY stage 108 may be performed alternately or simultaneously. That is, for example, the XY stage 108 is driven such that the alignment film 32 is moved to a predetermined position and stopped, and is rotated such that the polarization direction of the linearly polarized light transmitted through the λ/2 plate 104 is a predetermined direction. Next, the alignment film 32 is irradiated with the light beam from the light source 102 to expose a predetermined position on the surface of the alignment film 32, and the irradiation of the light is stopped. Next, the XY stage 108 is driven such that the alignment film 32 is moved to a next predetermined position (exposure position) and stopped, and is rotated such that the polarization direction of the linearly polarized light transmitted through the λ/2 plate 104 is a predetermined direction. Next, the alignment film 32 is irradiated with the light beam from the light source 102 to expose a predetermined position on the surface of the alignment film 32, and the irradiation of the light is stopped. This way, by alternately repeating the movement of the XY stage 108 and the irradiation of the light beam from the light source 102, the exposure of the alignment film 32 may be intermittently performed.

Alternatively, while driving the XY stage 108 to move the alignment film 32 in a predetermined direction and rotating the λ/2 plate 104, the surface of the alignment film 32 may be irradiated with the light beam from the light source 102 to continuously expose the surface of the alignment film 32.

Alternatively, for example, while irradiating a region corresponding to one center portion or one annular portion with the light beam from the light source 102, the XY stage 108 is driven to move the irradiation position in the circumferential direction of this region. Concurrently, the λ/2 plate is rotated according to the number of phase changes in the circumferential direction (the number of times the optical axis rotates) to expose the region. By repeating this exposure, each of the regions corresponding to the center portion or the annular portion may be exposed.

The intensity, exposure time, and the like of the light to be irradiated may be appropriately set depending on the material for forming the alignment film and the like.

The exposure amount per unit area can be adjusted by adjusting the intensity of the light to be irradiated and a scanning speed. From the viewpoint of performing sufficient exposure to apply aligning properties to the alignment film 32, the exposure amount is preferably 100 mJ/m² or more and more preferably 150 mJ/m². In addition, from the viewpoint of preventing a decrease in aligning properties caused by excessive irradiation, the exposure amount is preferably 5 J/m² or less and more preferably 3 J/m² or less.

In addition, the spot diameter of the focused light beam on the alignment film may be a size where a desired alignment pattern can be applied to the alignment film.

In addition, in the present invention, in order to obtain the configuration where the angles θ₁ and θ₂ of the optical axis in the fine regions of the liquid crystal layer satisfy Expression 3 and Expression 4, that is, in order to obtain the range of ±3 with respect to the angle of the optical axis acquired from Expression 3a and Expression 4a representing the above-described ideal vortex alignment pattern, it is necessary to improve the accuracy of exposure of the alignment film using the direct drawing method. To that end, in the present invention, in a case where the alignment film is exposed using the direct drawing method, a marker for alignment is given on the support 30 or the alignment film 32, and, in a case where the XY stage 108 is driven to align the exposure position of the alignment film 32 with a predetermined position, it is preferable that the marker is detected with the camera as described above, and the coordinates of the XY stage 108 are modified for alignment based on the position information of the marker. As a result, high-accuracy alignment can be performed, and a vortex alignment pattern capable of forming a liquid crystal layer where a variation in the angle of the optical axis with respect to the ideal vortex alignment pattern is small can be given to the alignment film.

During scanning in the circumferential direction of the center portion and each of the annular portions, the amount of change in the polarization angle of linearly polarized light (the rotation amount of the λ/2 plate 104) is preferably 45° or less. By finely performing the drawing, the change speed of the optical axis can be made to be fixed without depending on characteristics of the liquid crystal material.

The amount of movement of the movable stage is preferably ⅕ or less with respect to the length of the center portion and each of the annular portions in the circumferential direction. By finely performing the drawing, the change speed of the optical axis can be made to be fixed without depending on characteristics of the liquid crystal material.

The required accuracy of the amount of movement of the movable stage is preferably ⅕ or less, more preferably 1/10 or less, and still more preferably 1/20 or less with respect to the amount of movement Δr of the movable stage.

In the present invention, as described above, it is preferable that the marker is detected with the camera as described above, and the coordinates of the XY stage 108 are modified for alignment based on the position information of the marker.

In order to determine the position coordinates and the rotation angle of the alignment film 32 fixed to the XY stage 108, it is preferable to use a plurality of cameras during the alignment. By using the plurality of cameras, while maintaining an imaging magnification required for fine alignment, position coordinates of two points that are sufficiently spaced from each other on the alignment film 32 can be determined, and the sufficient accuracy for the position coordinates and the rotation angle can be ensured for the alignment.

As the marker, a single marker or a plurality of markers may be provided as long as the positions of two points that are sufficiently spaced from each other can be verified with a plurality of cameras. Here, the distance between the two points that are sufficiently spaced from each other is preferably 10 mm or more, more preferably 30 mm or more, still more preferably 50 mm or more, and still more preferably 80 mm or more.

In addition, it is also preferable that positions more than two points are simultaneously verified by a plurality of cameras.

In addition, a marker may be provided in at least one region, and it is preferable that markers are provided in three or more regions. By providing markers in three or more regions, the alignment can be performed using two markers provided at positions between which the exposure region is interposed in the X direction, and the alignment can be performed using two markers provided at positions between which the exposure region is interposed in the Y direction. Therefore, the coordinates of the XY stage can be more accurately aligned.

The shape of the marker can be any shape such as a cross shape, a dot shape, a linear shape, a circular shape, or a quadrangular shape. In addition, the marker may be an aggregate or a lattice.

### (Liquid Crystal Layer)

The liquid crystal layer is formed on the surface of the alignment film 32.

As described above, the liquid crystal layer is obtained by immobilizing the liquid crystal phase where the liquid crystal compound is aligned, and has the vortex alignment pattern.

### <<Method of Forming Liquid Crystal Layer>>

The liquid crystal layer can be formed by immobilizing the liquid crystal phase where the liquid crystal compound is aligned in the vortex alignment pattern.

The structure in which a liquid crystal phase is immobilized may be a structure in which the alignment of the liquid crystal compound as a liquid crystal phase is immobilized. Typically, the structure in which a liquid crystal phase is immobilized is preferably a structure which is obtained by aligning the polymerizable liquid crystal compound in the liquid crystal alignment pattern, polymerizing and curing the polymerizable liquid crystal compound with ultraviolet irradiation, heating, or the like to form a layer having no fluidity, and concurrently changing the state of the polymerizable liquid crystal compound into a state where the alignment state is not changed by an external field or an external force.

The structure in which a liquid crystal phase is immobilized is not particularly limited as long as the optical characteristics of the liquid crystal phase are maintained, and the liquid crystal compound 40 in the liquid crystal layer does not necessarily exhibit liquid crystallinity. For example, the molecular weight of the polymerizable liquid crystal compound may be increased by a curing reaction such that the liquid crystallinity thereof is lost.

Examples of a material used for forming the liquid crystal layer obtained by immobilizing a liquid crystal phase include a liquid crystal composition including a liquid crystal compound. It is preferable that the liquid crystal compound is a polymerizable liquid crystal compound.

In addition, the liquid crystal composition used for forming the liquid crystal layer may further include a surfactant and a polymerization initiator.

### ——Polymerizable Liquid Crystal Compound——

The polymerizable liquid crystal compound may be a rod-like liquid crystal compound or a disk-like liquid crystal compound.

Examples of the polymerizable liquid crystal compound for forming the rod-like liquid crystal layer include a rod-like nematic liquid crystal compound. As the rod-like nematic liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. Not only a low-molecular-weight liquid crystal compound but also a polymer liquid crystal compound can be used.

It is preferable that the alignment of the rod-like liquid crystal compound is immobilized by polymerization. Examples of the polymerizable rod-like liquid crystal compound include compounds described in Makromol. Chem., (1989), Vol. 190, p. 2255, Advanced Materials (1993), Vol. 5, p. 107, U.S. Pat. Nos. 4,683,327A, 5,622,648A, 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-64627. Further, as the rod-like liquid crystal compound, for example, compounds described in JP1999-513019A (JP-H11-513019A) and JP2007-279688A can also be preferably used. In addition, two or more kinds of polymerizable liquid crystal compounds may be used in combination. In a case where two or more polymerizable liquid crystal compounds are used in combination, the alignment temperature can be decreased.

Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups in the polymerizable liquid crystal compound is preferably 1 to 6 and more preferably 1 to 3.

In addition, as a polymerizable liquid crystal compound other than the above-described examples, for example, a cyclic organopolysiloxane compound having a cholesteric phase described in JP1982-165480A (JP-S57-165480A) can be used. Further, as the above-described polymer liquid crystal compound, for example, a polymer in which a liquid crystal mesogenic group is introduced into a main chain, a side chain, or both a main chain and a side chain, a polymer cholesteric liquid crystal in which a cholesteryl group is introduced into a side chain, a liquid crystal polymer described in JP1997-133810A (JP-H9-133810A), and a liquid crystal polymer described in JP1999-293252A (JP-H11-293252A) can be used.

### ——Disk-Like Liquid Crystal Compound——

As the disk-like liquid crystal compound, for example, compounds described in JP2007-108732A and JP2010-244038A can be preferably used.

In a case where the disk-like liquid crystal compound is used in the liquid crystal layer, the liquid crystal compound 40 rises in the thickness direction in the liquid crystal layer, and the optical axis 40A derived from the liquid crystal compound is defined as an axis perpendicular to a disc plane, that is, a so-called fast axis.

In addition, the addition amount of the polymerizable liquid crystal compound in the liquid crystal composition is preferably 75 to 99.9 mass %, more preferably 80 to 99 mass %, and still more preferably 85 to 90 mass % with respect to the solid content mass (mass excluding a solvent) of the liquid crystal composition.

In order to obtain a high diffraction efficiency, it is preferable that a liquid crystal compound having high refractive anisotropy Δn is used as the liquid crystal compound.

### ——Surfactant——

The liquid crystal composition used for forming the liquid crystal layer may include a surfactant.

The surfactant is preferably a compound which can function as an alignment control agent contributing to the alignment of the liquid crystal compound in a stable or rapid manner. Examples of the surfactant include a silicone-based surfactant and a fluorine-based surfactant. Among these, a fluorine-based surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and paragraphs “0082” to “0085” of JP2002-129162A, and fluorine (meth)acrylate polymers described in paragraphs “0018” to “0043” of JP2007-272185A.

The surfactants may be used alone or in combination of two or more kinds.

As the fluorine-based surfactant, a compound described in paragraphs “0082” to “0090” of JP2014-119605A is preferable.

The addition amount of the surfactant in the liquid crystal composition is preferably 0.01 to 10 mass %, more preferably 0.01 to 5 mass %, and still more preferably 0.02 to 2 mass % with respect to the total mass of the liquid crystal compound.

### ——Polymerization Initiator——

In a case where the liquid crystal composition includes a polymerizable compound, it is preferable that the liquid crystal composition includes a polymerization initiator. In an aspect where a polymerization reaction progresses with ultraviolet irradiation, it is preferable that the polymerization initiator to be used is a photopolymerization initiator which initiates a polymerization reaction with ultraviolet irradiation.

Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triarylimidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of the photopolymerization initiator in the liquid crystal composition is preferably 0.1 to 20 mass % and more preferably 0.5 to 12 mass % with respect to the content of the liquid crystal compound.

### ——Crosslinking Agent——

In order to improve the film hardness after curing and to improve durability, the liquid crystal composition may optionally include a crosslinking agent. As the crosslinking agent, a curing agent which can perform curing with ultraviolet light, heat, moisture, or the like can be suitably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an compound such aziridine as 2,2-bis hydroxymethyl butanol-tris [3-(1-aziridinyl) propionate] or 4,4-bis(ethyleneiminocarbonylamino)diphenylmethane; an isocyanate compound such as hexamethylene diisocyanate or a biuret type isocyanate; a polyoxazoline compound having an oxazoline group at a side chain thereof; and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. The crosslinking agents may be used alone or in combination of two or more kinds.

The content of the crosslinking agent is preferably 3% to 20 mass % and more preferably 5% to 15 mass % with respect to the solid content mass of the liquid crystal composition. In a case where the content of the crosslinking agent is in the above-described range, an effect of improving a crosslinking density can be easily obtained, and the stability of a liquid crystal phase is further improved.

### ——Other Additives——

Optionally, a polymerization inhibitor, an antioxidant, an ultraviolet absorber, a light stabilizer, a coloring material, metal oxide fine particles, or the like can be added to the liquid crystal composition in a range where optical performance and the like do not deteriorate.

In a case where the liquid crystal layer is formed, it is preferable that the liquid crystal composition is used as liquid.

The liquid crystal composition may include a solvent. The solvent is not particularly limited and can be appropriately selected depending on the purpose. An organic solvent is preferable.

The organic solvent is not particularly limited and can be appropriately selected depending on the purpose. Examples of the organic solvent include a ketone, an alkyl halide, an amide, a sulfoxide, a heterocyclic compound, a hydrocarbon, an ester, and an ether. The organic solvents may be used alone or in combination of two or more kinds. Among these, a ketone is preferable in consideration of an environmental burden.

In a case where the liquid crystal layer is formed, it is preferable that the liquid crystal layer is formed by applying the liquid crystal composition to a surface where the liquid crystal layer is to be formed, aligning the liquid crystal compound to a state where the liquid crystal phase is aligned in the predetermined liquid crystal alignment pattern, and curing the liquid crystal compound.

That is, in a case where the liquid crystal layer is formed on the alignment film 32, it is preferable that the liquid crystal layer obtained by immobilizing a liquid crystal phase is formed by applying the liquid crystal composition to the alignment film 32, aligning the liquid crystal compound in the predetermined liquid crystal alignment pattern, and curing the liquid crystal compound.

For the application of the liquid crystal composition, a printing method such as ink jet or scroll printing or a well-known method such as spin coating, bar coating, or spray coating capable of uniformly applying liquid to a sheet-shaped material can be used.

The applied liquid crystal composition is optionally dried and/or heated and then is cured to form the liquid crystal layer. In the drying and/or heating step, the liquid crystal compound in the liquid crystal composition may be aligned in the predetermined liquid crystal alignment pattern. In the case of heating, the heating temperature is preferably 200° C. or lower and more preferably 130° C. or lower.

The aligned liquid crystal compound is optionally further polymerized. Regarding the polymerization, thermal polymerization or photopolymerization using light irradiation may be performed, and photopolymerization is preferable. Regarding the light irradiation, ultraviolet light is preferably used. The irradiation energy is preferably 20 mJ/cm² to 50 J/cm² and more preferably 50 to 1500 mJ/cm². In order to promote a photopolymerization reaction, light irradiation may be performed under heating conditions or in a nitrogen atmosphere. The wavelength of irradiated ultraviolet light is preferably 250 to 430 nm.

A thickness of the liquid crystal layer is not particularly limited and may be appropriately set depending on the use of the liquid crystal layer, the material for forming the liquid crystal layer, and the like.

In the liquid crystal layer, it is preferable that an in-plane retardation (Re) value in the fine regions is a half wavelength, that is, λ/2. The in-plane retardation is calculated from the product of a difference Δn in refractive index generated by refractive index anisotropy of the region and the thickness of the liquid crystal layer. Here, the difference in refractive index generated by refractive index anisotropy of the region in the liquid crystal layer is defined by a difference between a refractive index of a direction of an in-plane slow axis of the region and a refractive index of a direction orthogonal to the direction of the slow axis. That is, the difference Δn in refractive index generated by refractive index anisotropy of the region R is the same as a difference between a refractive index of the liquid crystal compound in the direction of the optical axis and a refractive index of the liquid crystal compound in a direction perpendicular to the optical axis in a plane of the region. That is, the difference Δn in refractive index is the same as the difference in refractive index of the liquid crystal compound.

In the liquid crystal layer, it is preferable that the in-plane retardation value of the plurality of regions is a half wavelength. It is preferable that an in-plane retardation Re(550)=Δn₅₅₀×d of the plurality of regions of the liquid crystal layer with respect to the incidence light having a wavelength of 550 nm is in a range defined by Expression (3). Here, Δn₅₅₀ represents a difference in refractive index generated by refractive index anisotropy of the region in a case where the wavelength of incidence light is 550 nm, and d represents the thickness of the liquid crystal layer.

$$200 nm \leq Δ {n}_{550} \times d \leq 350 nm \qquad ( 3 )$$

That is, in a case where the in-plane retardation Re(550)=Δn₅₅₀×d of the plurality of regions of the liquid crystal layer satisfies Expression (3), a sufficient amount of a circularly polarized light component in light incident into the liquid crystal layer can be converted into circularly polarized light that travels in a direction tilted in a forward direction or reverse direction with respect to the arrangement axis direction. It is more preferable that the in-plane retardation Re(550)=Δn₅₅₀×d satisfies 225 nm≤Δn₅₅₀×d≤340 nm, and it is still more preferable that the in-plane retardation Re(550)=Δn₅₅₀×d satisfies 250 nm≤Δn₅₅₀×d≤330 nm.

Expression (3) is a range with respect to incidence light having a wavelength of 550 nm. However, an in-plane retardation Re(λ)=Δn_{λ}×d of the plurality of regions of the liquid crystal layer with respect to incidence light having a wavelength of λ nm is preferably in a range defined by Expression (3-2) and can be appropriately set.

$$0.7 \times ( λ / 2 ) nm \leq Δ {n}_{λ} \times d \leq 1.3 \times ( λ / 2 ) nm \qquad ( 3 - 2 )$$

In addition, the value of the in-plane retardation of the plurality of regions of the liquid crystal layer in a range outside the range of Expression (3) can also be used. Specifically, by satisfying Δn₅₅₀×d<200 nm or 350 nm<Δn₅₅₀×d, the light can be classified into light that travels in the same direction as a traveling direction of the incidence light and light that travels in a direction different from a traveling direction of the incidence light. In a case where Δn₅₅₀×d approaches 0 nm or 550 nm, the amount of the light component that travels in the same direction as a traveling direction of the incidence light increases, and the amount of the light component that travels in a direction different from a traveling direction of the incidence light decreases.

Further, it is preferable that an in-plane retardation Re(450)=Δn₄₅₀×d of each of the plurality of regions of the liquid crystal layer with respect to incidence light having a wavelength of 450 nm and an in-plane retardation Re(550)=Δn₅₅₀×d of each of the plurality of regions of the liquid crystal layer with respect to incidence light having a wavelength of 550 nm satisfy Expression (4). Here, Δn₄₅₀ represents a difference in refractive index generated by refractive index anisotropy of the region in a case where the wavelength of incidence light is 450 nm.

$$( Δ {n}_{450} \times d ) / ( Δ {n}_{550} \times d ) < 1.0 \qquad ( 4 )$$

Expression (4) represents that the liquid crystal compound in the liquid crystal layer has reverse dispersibility. That is, by satisfying Expression (4), the liquid crystal layer can correspond to incidence light having a wide range of wavelength.

Although the liquid crystal layer functions as a so-called λ/2 plate, the present invention includes an aspect where a laminate including the support and the alignment film that are integrated functions as a λ/2 plate.

Here, in the liquid crystal layer, it is preferable that (the optical axis of) the liquid crystal compound is subjected to a twisted alignment in the thickness direction. “The liquid crystal compound (optical axis) being twisted and aligned in the thickness direction” refers to a state where the orientation of the optical axis arranged in the thickness direction from one main surface to another main surface of the liquid crystal layer relatively changes and is twisted and aligned in the one direction. The twisting property may be right-twisted or left-twisted and may be applied depending on a desired diffraction direction. The optical axis in the entire thickness direction is twisted by less than one turn, that is, the twisted angle is less than 360°. The twisted angle of the liquid crystal compound in the thickness direction is preferably about 10° to 200° and more about preferably 20° to 180°. In addition, the twisted direction may be reversed halfway in the thickness direction. Even in this case, the twisted angle is less than 360°, and the twisted angle of the liquid crystal compound in the thickness direction is preferably about 10° to 200° and more about preferably 20° to 180°. In the cholesteric alignment, the twisted angle is 360° or more, and selective reflectivity in which specific circularly polarized light in a specific wavelength range is reflected is exhibited. In the present specification, “twisted alignment” does not include cholesteric alignment, and selective reflectivity does not occur in the liquid crystal layer having the twisted alignment.

The liquid crystal layer that is twisted and aligned in the thickness direction has a twisted structure in which the liquid crystal compound is turned and laminated in the thickness direction, and a total rotation angle between the liquid crystal compound present on one main surface side of the liquid crystal layer and the liquid crystal compound present on another main surface side of the liquid crystal layer is less than 360°.

This way, in order for the liquid crystal layer to have the configuration where the liquid crystal compound is twisted and aligned in the thickness direction, the liquid crystal composition for forming the liquid crystal layer may include a chiral agent.

### ——Chiral Agent (Optically Active Compound)——

The chiral agent has a function of causing a helical structure of a liquid crystal phase to be formed. The chiral agent may be selected depending on the purposes because a helical twisted direction and a helical twisting power (HTP) to be induced vary depending on compounds.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide, or an isomannide derivative can be used.

In general, the chiral agent includes a chiral carbon atom. However, an axially chiral compound or a planar chiral compound not having a chiral carbon atom can also be used as the chiral agent. Examples of the axially chiral compound or the planar chiral compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent includes a photoisomerization group, a desired twisted alignment corresponding to a luminescence wavelength can be formed by irradiation of an actinic ray or the like through a photomask after coating and alignment, which is preferable. As the photoisomerization group, an isomerization portion of a photochromic compound, an azo group, an azoxy group, or a cinnamoyl group is preferable. Specific examples of the compound include compounds described in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A.

The content of the chiral agent in the liquid crystal composition is preferably 0.01% to 200 mol % and more preferably 1% to 30 mol % with respect to the content molar amount of the liquid crystal compound.

In all of the above-described liquid crystal layers, the rod-like liquid crystal compound is used as the liquid crystal compound. However, the present invention is not limited to this configuration, and a disk-like liquid crystal compound can also be used.

In the disk-like liquid crystal compound, the optical axis derived from the liquid crystal compound is defined as an axis perpendicular to a disk surface, that is so-called, a fast axis.

In addition, in the liquid crystal layer of the lens device according to the embodiment of the present invention, the rod-like liquid crystal compound and the disk-like liquid crystal compound may be used in combination.

In addition, the planar shape of the lens device (liquid crystal layer) is not limited to a circular shape, and may be appropriately set to a rectangular shape, an elliptical shape, or an amorphous shape depending on the configuration of the device used in the lens device.

### [Image Display Apparatus and Head Mounted Display]

The lens device according to the embodiment of the present invention can be combined with a display panel to obtain an image display apparatus.

The image display apparatus including the lens device according to the embodiment of the present invention can be suitably used as an image display apparatus of a head mounted display such as augmented reality (AR) glasses, VR glasses, or mixed reality (MR) glasses.

Hereinabove, the lens device according to the embodiment of the present invention has been described above. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Example 1

### <Preparation of First Liquid Crystal Layer>

### (Support)

A flat plate-shaped glass substrate was prepared as the support.

### (Formation of Alignment Film)

The following coating liquid for forming an alignment film was applied to the support by spin coating. The support on which the coating film of the coating liquid for forming an alignment film was formed was dried using a hot plate at 60° C. for 60 seconds. As a result, an alignment film was formed.

### Coating Liquid for Forming Alignment Film

| | |
|---|---|
| Material A for photo-alignment | 1.00 part by mass |
| Water | 16.00 parts by mass |
| Butoxyethanol | 42.00 parts by mass |
| Propylene glycol monomethyl ether | 42.00 parts by mass |

### —Material A for Photo-Alignment—

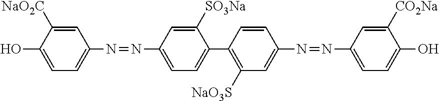

### (Exposure of Alignment Film)

Using a laser light source of a wavelength of 355 nm, a linearly polarizing plate, a λ/2 plate, a lens, and an XY stage (LD-242-MSC, manufactured by Chuo Precision Industrial Co., Ltd.), an exposure device for performing a direct drawing method was manufactured as shown in FIG. 17. The alignment film was exposed using the exposure device to form an alignment film P-1 for aligning the liquid crystal compound in a vortex alignment pattern shown in FIG. 18.

Specifically, the support on which the alignment film was formed was placed on the XY stage, and the lens position was adjusted such that the focusing position was the surface of the alignment film. As the light source, a light source that emitted laser light having a wavelength (355 nm) was used. Next, the movement of the XY stage and the rotation of the λ/2 plate were synchronized such that the alignment direction of the liquid crystal compound (optical axis) is the alignment direction for obtaining the vortex alignment pattern shown in FIG. 18, and the exposure was performed such that the direction of linearly polarized light of laser light with which each of the locations was irradiated was a predetermined direction. As a result, the alignment film P-1 was formed.

### (Formation of Liquid Crystal Layer)

As the liquid crystal composition forming the liquid crystal layer, the following composition A-1 was prepared.

### Composition A-1

| | |
|---|---|
| Liquid crystal compound L-1 | 100.00 parts by mass |
| Polymerization initiator | 1.00 part by mass |
| (manufactured by BASF, Irgacure OXE01) | |
| Leveling agent T-1 | 0.08 parts by mass |
| Methyl ethyl ketone | 1050.00 parts by mass |

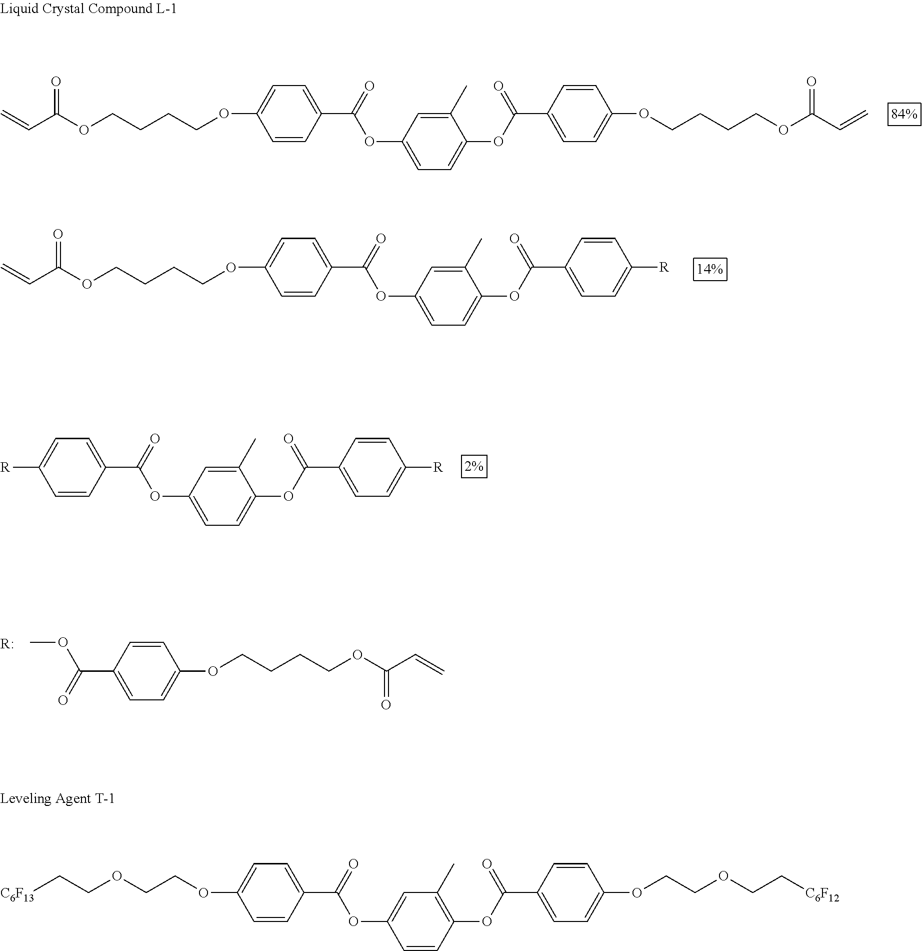

The liquid crystal layer was formed by applying multiple layers of the composition A-1 to the alignment film P-1. The application of the multiple layers refers to repetition of the following processes including: preparing a first liquid crystal immobilized layer by applying the composition A-1 for forming the first layer to the alignment film, heating the composition A-1, and irradiating the composition A-1 with ultraviolet light for curing; and manufacturing a second or subsequent liquid crystal immobilized layer by applying the composition A-1 for forming the second or subsequent layer to the formed liquid crystal immobilized layer, heating the composition A-1, and irradiating the composition A-1 with ultraviolet light for curing as described above. Even in a case where the liquid crystal layer was formed by the application of the multiple layers such that the total thickness of the optically-anisotropic layer was large, the alignment direction of the alignment film was reflected from a lower surface of the liquid crystal layer to an upper surface thereof.

Regarding the first liquid crystal layer, the following composition A-1 was applied to the alignment film P-1 to form a coating film, the coating film was heated to 80° C. using a hot plate, the coating film was irradiated with ultraviolet light having a wavelength of 365 nm at an irradiation dose of 300 mJ/cm² using a high-pressure mercury lamp in a nitrogen atmosphere. As a result, the alignment of the liquid crystal compound was immobilized.

Regarding the second or subsequent liquid crystal immobilized layer, the composition was applied to the first liquid crystal layer, and the applied composition was heated and irradiated with ultraviolet light for curing under the same conditions as described above. As a result, a liquid crystal immobilized layer was manufactured. This way, by repeating the application multiple times until the total thickness reached a desired film thickness, and the first liquid crystal layer was formed. The thickness of the first layer was 1.8 μm.

It was verified using a polarization microscope that the first liquid crystal layer had the vortex alignment pattern shown in FIG. 18. In addition, the diameter of the first liquid crystal layer was 4 mm.

### <Preparation of Second Liquid Crystal Layer>

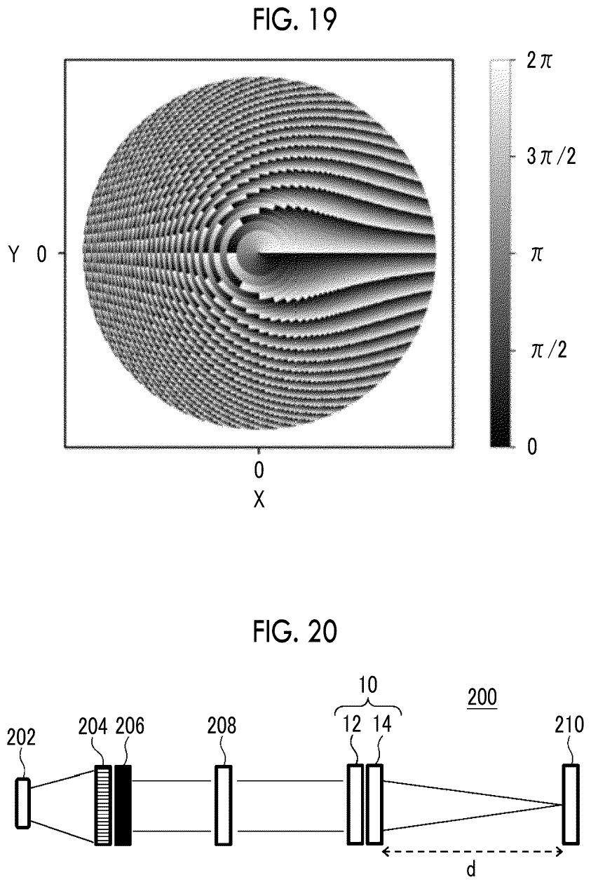

A second liquid crystal layer was prepared using the same method as that of the first liquid crystal layer, except that the second liquid crystal layer has a vortex alignment pattern different from the vortex alignment pattern of the first liquid crystal layer as shown in FIG. 19.

### <Preparation of Lens Device>

By laminating the prepared first liquid crystal layer and the prepared second liquid crystal layer to be rotatable relative to each other, a lens device was prepared. The first liquid crystal layer and the second liquid crystal layer were in contact with each other.

### [Evaluation]

### <Evaluation of Focal Length>

Using an evaluation system conceptually shown in FIG. 20, whether the focal length of the prepared lens device was variable was evaluated.

The evaluation system 200 shown in FIG. 20 includes a light source 202, a louver film 204, a louver film 206, a band pass filter 208, and a screen 210, in which the first liquid crystal layer 12 and the second liquid crystal layer 14 are disposed between the band pass filter 208 and the screen 210.

As the light source 202, a white LED light source was used. As the louver film 204 and the louver film 206, a security/privacy filter PF240W2E (manufactured by 3M) was used. In addition, the louver film 204 and the louver film 206 were disposed such that the louvers were orthogonal to each other. As the band pass filter 208, a band pass filter (#65-155, manufactured by Edmund Optics Inc.) that allowed transmission of only green light was used. As the screen 210, white paper was used.

By emitting white light from the light source 202 and allowing the white light to transmit the two louver films, parallel light was obtained. Next, the parallel light was allowed to transmit through the band pass filter 208 to obtain green light. By allowing the green light to transmit through the first liquid crystal layer 12 and the second liquid crystal layer 14 in this order, the screen 210 was irradiated with the transmitted light. The screen 210 was moved in the optical axis direction to a position at which the spot diameter of light in the screen 210 was the minimum, and a distance d between the second liquid crystal layer 14 and the screen 210 in this case was obtained as the focal length.

In a case where the relative angle between the first liquid crystal layer 12 and the second liquid crystal layer 14 was 30°, the focal length was 73 cm. In addition, in a case where the relative angle between the first liquid crystal layer 12 and the second liquid crystal layer 14 was 60°, the focal length was 35 cm. In addition, in a case where the relative angle between the first liquid crystal layer 12 and the second liquid crystal layer 14 was 90°, the focal length was 25 cm.

As described above, it was able to be verified that the focal length was changed by changing the relative angle between the first liquid crystal layer 12 and the second liquid crystal layer 14. It can be seen that, in the lens device according to the embodiment of the present invention, the thickness in the optical axis direction of the lens was thin, and the focal length was variable without changing the size in the in-plane direction.

### [Simulation]

The influence of a variation in the optical axis θ₁ in the first liquid crystal layer 12 and the second liquid crystal layer 14 was verified by simulation.

In the first liquid crystal layer 12 and the second liquid crystal layer 14 prepared in Example 1, the angle of the optical axis of the first liquid crystal layer 12 was represented by θ₁={α₁×φ₁+θ₀ₙ₁}∓α, the angle of the optical axis of the second liquid crystal layer 14 was represented by θ₂={α₂×φ₂+θ₀ₙ₂}±α, random numbers were generated between +a while changing a to 0°, 0.5°, 1.0°, 2.5°, 5.0°, and 7.5°, and a case where there was a variation in the vortex alignment patterns (the angles of the optical axis) of the first liquid crystal layer 12 and the second liquid crystal layer 14 was simulated. In the first liquid crystal layer 12 and the second liquid crystal layer 14 prepared in Example 1, θ₀ₙ₁=0° and θ₀ₙ₂=0°.

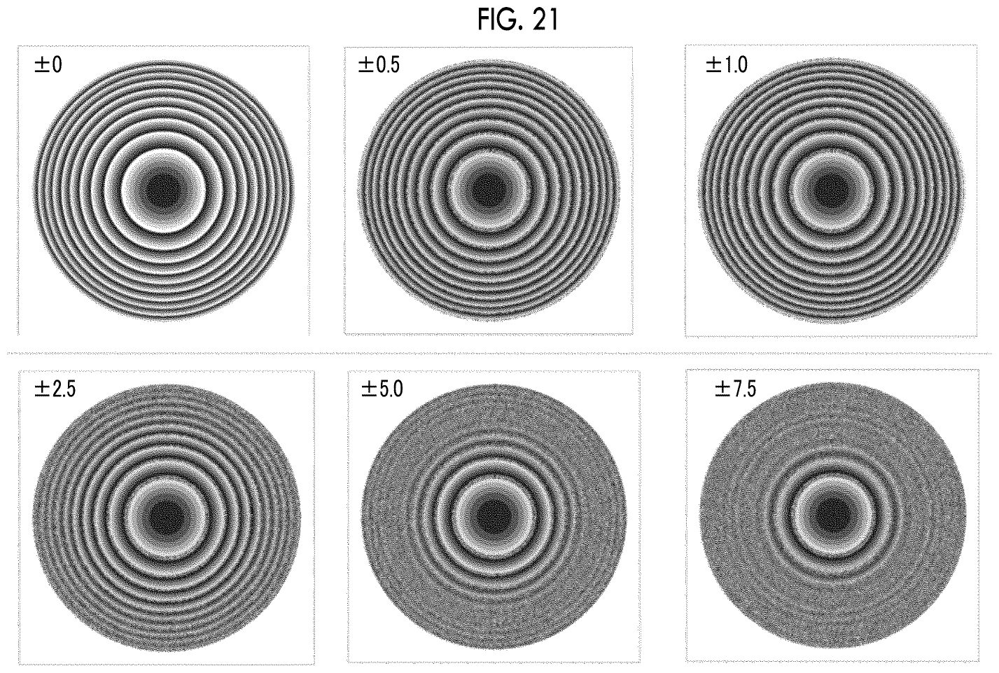

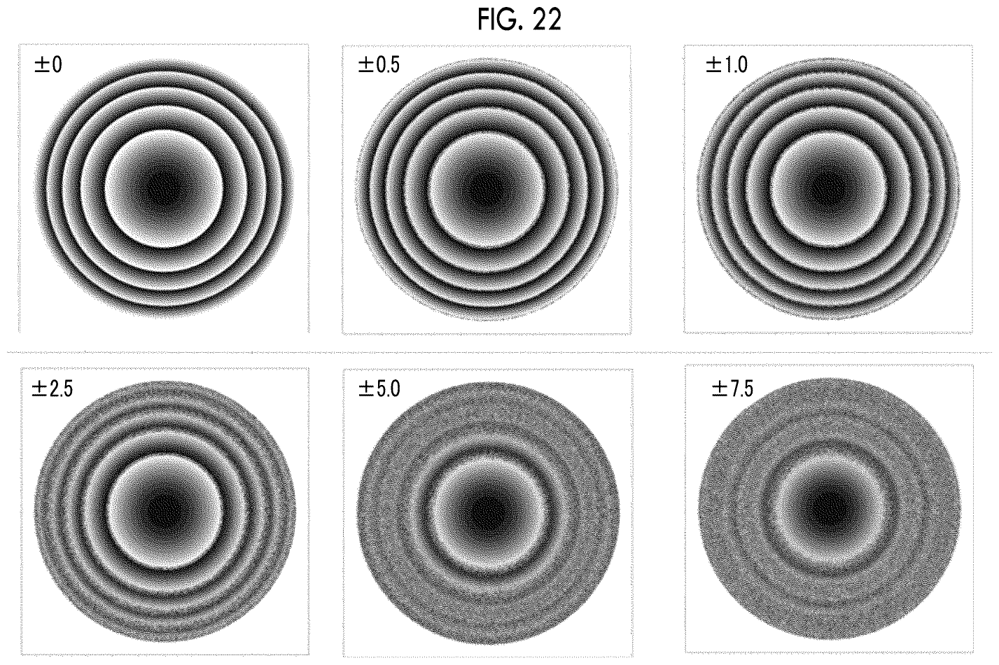

In a case where the relative angle between the first liquid crystal layer 12 and the second liquid crystal layer 14 was 60°, the phase of the laminate of the first liquid crystal layer 12 and the second liquid crystal layer 14 was obtained by simulation. The results thereof are shown in FIG. 21. In FIG. 21, the diagrams showing ±0 to ±7.5 are results of cases where a is 0° to 7.5°, respectively.

Likewise, in a case where the relative angle between the first liquid crystal layer 12 and the second liquid crystal layer 14 was 30°, the phase of the laminate of the first liquid crystal layer 12 and the second liquid crystal layer 14 was obtained by simulation. The result is shown in FIG. 22. In FIG. 22, the diagrams showing ±0 to ±7.5 are results of cases where a is 0° to 7.5°, respectively.

It can be seen from FIGS. 21 and 22 that, as a increases from 0°, that is, the ideal state, the phase change is disordered such that the boundary is blurred. In addition, in a case where a is 2.5° or less, the phase change in the radial direction sufficiently occurs, and thus the laminate appropriately functions as a lens. On the other hand, it can be seen that, in a case where a is 5° or more, the phase change in the radial direction does not sufficiently occur. In this case, the laminate appropriately does not function as a lens.

As can be seen from the above results, the effects of the present invention are obvious.

### EXPLANATION OF REFERENCES

10: lens device
12: first liquid crystal layer
14: second liquid crystal layer
20a, 20b: center portion
21a, 21b: first annular portion
22a, 22b: second annular portion
30: support
32: alignment film
40: optical axis (liquid crystal compound)
100: exposure device
102: light source
104: λ/2 plate
106: lens
108: XY stage
200: evaluation system
202: light source
204, 206: louver film
208: band pass filter
210: screen

What is claimed is:

1. A lens device comprising:
a first liquid crystal layer; and
a second liquid crystal layer,
wherein each of the first liquid crystal layer and the second liquid crystal layer includes a circular center portion and a plurality of annular portions that have centers matching with a center of the center portion and have different inner diameters provided in a radial direction of the center portion,
the center of the center portion of the first liquid crystal layer and the center of the center portion of the second liquid crystal layer match with each other in an in-plane direction,
the first liquid crystal layer and the second liquid crystal layer are rotatable relative to each other around the center of the center portion of the first liquid crystal layer without changing a distance between the first liquid crystal layer and the second liquid crystal layer,
an inner diameter rᵢₙ₋ₙ₁ and an outer diameter rₒᵤₜ₋ₙ₁ of an n-th annular portion from the center portion of the first liquid crystal layer and an inner diameter rᵢₙ₋ₙ₂ and an outer diameter rₒᵤₜ₋ₙ₂ of an n-th annular portion from the center portion of the second liquid crystal layer satisfy relationships represented by Expression 1 and Expression 2,
$$0 \text{.9} \times {r}_{i n - n 1} \leq {r}_{i n - n 2} \leq 1.1 \times {r}_{i n - n 1} , \qquad Expression 1$$
$$and$$
$$0.9 \times {r}_{out - n 1} \leq {r}_{out - n 2} \leq 1.1 \times {r}_{out - n 1} , \qquad Expression 2$$
in polar coordinates of r and q with respect to the center of the center portion of the first liquid crystal layer as an origin, in a case where a pattern where an angle θ₁ [°] of an optical axis of the first liquid crystal layer in a region where φ is φ₁ satisfies a relationship represented by Expression 3 is set as a vortex alignment pattern,
$$\{ {α}_{1} \times {φ}_{1} + {θ}_{0 n 1} \} - 3 ° \leq {θ}_{1} \leq \{ {α}_{1} \times {φ}_{1} + {θ}_{0 n 1} \} + 3 ° , \qquad Expression 3$$
where θ₀ₙ₁ [°] represents an angle of the optical axis of each of the center portion and the annular portions at φ₁=0°,
the center portion of the first liquid crystal layer has a vortex alignment pattern where α₁=m×0.5 in a case where m represents an integer of 1 or more, and
the n-th annular portion from the center portion of the first liquid crystal layer has a vortex alignment pattern where α₁=(m+n)×0.5, and
in polar coordinates of r and φ with respect to the center of the center portion of the second liquid crystal layer as an origin, in a case where a pattern where an angle θ₂ [°] of an optical axis of the second liquid crystal layer in a region where φ is φ₂ satisfies a relationship represented by Expression 4 is set as a vortex alignment pattern,
$$\{ {α}_{2} \times {φ}_{2} + {θ}_{0 n 2} \} - 3 ° \leq {θ}_{2} \leq \{ {α}_{2} \times {φ}_{2} + {θ}_{0 n 2} \} + 3 ° , \qquad Expression 4$$
where θ₀ₙ₂ [°] represents an angle of the optical axis of each of the center portion and the annular portions at φ₂=0°,
the center portion of the second liquid crystal layer has a vortex alignment pattern where α₂=−(m×0.5) in a case where m represents an integer of 1 or more, and
the n-th annular portion from the center portion of the second liquid crystal layer has a vortex alignment pattern where α₂=−(m+n)×0.5.

2. The lens device according to claim 1,
wherein in a case where an azimuthal angle at which the optical axis is parallel to the radial direction in the n-th annular portion from the center portion with respect to an orientation at which the optical axis is parallel to the radial direction in the center portion of the first liquid crystal layer is represented by φₙ₁, and
an azimuthal angle at which the optical axis is parallel to the radial direction in the n-th annular portion from the center portion with respect to an orientation at which the optical axis is parallel to the radial direction in the center portion of the second liquid crystal layer is represented by φₙ₂,
φₙ₁=φₙ₂ is satisfied.

3. The lens device according to claim 2,
wherein in a case where the azimuthal angle at which the optical axis is parallel to the radial direction in the center portion of the first liquid crystal layer is represented by φ₀₁, φₙ₁=φ₀₁ is satisfied, and
in a case where the azimuthal angle at which the optical axis is parallel to the radial direction in the center portion of the second liquid crystal layer is represented by φ₀₂, φₙ₂=φ₀₂ is satisfied.

4. The lens device according to claim 1, which functions as an axicon lens.

5. The lens device according to claim 1, which functions as a spherical lens.

6. The lens device according to claim 1, which functions as an aspherical lens.

7. The lens device according to claim 2, which functions as an axicon lens.

8. The lens device according to claim 2, which functions as a spherical lens.

9. The lens device according to claim 2, which functions as an aspherical lens.

10. The lens device according to claim 3, which functions as an axicon lens.

11. The lens device according to claim 3, which functions as a spherical lens.

12. The lens device according to claim 3, which functions as an aspherical lens.
